(19) United States
(12) Patent Application Publication
(10) Pub. No.: US 2026/0032400 A1
(43) Pub. Date: Jan. 29, 2026

(54) APPARATUS AND METHOD FOR BINAURAL POSE CORRECTION

(71) Applicant: Fraunhofer-Gesellschaft zur Förderung der angewandten Forschung e.V., München (DE)

(72) Inventors: Archit TAMARAPU, Erlangen (DE); Dominik WECKBECKER, Erlangen (DE); Stefan DÖHLA, Erlangen (DE); Dominik HÄUßLER, Erlangen (DE); Jan Frederik KIENE, Erlangen (DE); Markus MULTRUS, Erlangen (DE); Kacper SAGNOWSKI, Erlangen (DE); Karin PREBECK, Erlangen (DE)

(21) Appl. No.: 19/349,429

(22) Filed: Oct. 3, 2025

Related U.S. Application Data
(63) Continuation of application No. PCT/EP2024/059166, filed on Apr. 4, 2024.

(30) Foreign Application Priority Data
Apr. 5, 2023 (WO) PCT/EP2023/059074

(51) Int. Cl. H04S 7/00; H04R 5/033; H04S 3/00

(52) U.S. Cl. CPC H04S 7/304; H04R 5/033; H04S 3/008; H04S 2400/01; H04S 2400/11

(57) ABSTRACT

An apparatus for processing two or more first binaural signals according to an embodiment is provided. The apparatus has an audio processor configured for conducting a weighted mixing of the two or more first binaural signals to obtain a combined binaural signal. The two or more first binaural signals are two or more binaural audio signals for different rotations of a same audio scene.

### CROSS-REFERENCE TO RELATED APPLICATIONS

This application is a continuation of copending International Application No. PCT/EP2024/059166, filed Apr. 4, 2024, which is incorporated herein by reference in its entirety, and additionally claims priority from International Application No. PCT/EP2023/059074, filed Apr. 5, 2023, which is also incorporated herein by reference in its entirety.

### TECHNICAL FIELD

The present invention relates to binaural pose correction and, in particular, to an apparatus and a method for binaural pose correction.

### BACKGROUND OF THE INVENTION

In Augmented Reality (AR)/Virtual Reality (VR), one of the key goals is to provide a sensation that resembles reality or a plausible alternative to reality, which is often not possible due to non-realistic sensations such as mediocre media quality and media that is not accurate when a user moves but the media rather corresponds to an outdated pose.

To avoid delays between obtaining pose data and conducting a pose update, low-complexity and low-latency solutions have been provided, which can be utilized directly on a lightweight device to perform a pose update to compensate for any deviation in the head pose. Known solutions utilize frequency domain processing, for example, the Dynamic Binaural Cue Adaptation method from Nagel and Jax, [1]: Nagel, S., & Jax, P. “Dynamic binaural cue adaptation”, In 2018 16th International Workshop on Acoustic Signal Enhancement (IWAENC), pp. 96-100, IEEE, September 2018) or the CLDFB domain covariance approach contributed by Dolby to the IVAS Codec Public Collaboration, [2]: https://forge.3gpp.org/rep/ivas-codec-pc/ivas-codec/-/wikis/Contributions/21-Split-Rendering).

Bilinear interpolation on a set of impulse responses to obtain an interpolated response for a missing position is described, e.g., in [3], Freeland, F. P., Biscainho, L. W., & Diniz, P. S. (2004 September). Interpolation of head-related transfer functions (HRTFs): A multi-source approach. In 2004 12th European Signal Processing Conference (pp. 1761-1764). IEEE).

The object of the present invention is to provide improved concepts for binaural pose correction.

### SUMMARY

According to an embodiment, an apparatus for processing two or more first binaural signals may have: an audio processor configured for conducting a weighted mixing of the two or more first binaural signals to obtain a combined binaural signal, wherein the two or more first binaural signals are two or more binaural audio signals for different rotations of a same audio scene.

Another embodiment may have an apparatus for generating two or more binaural signals, wherein the apparatus is configured for generating the two or more binaural signals being two or more binaural audio signals for different rotations of a same audio scene.

According to another embodiment, a system may have: one or more apparatuses for processing two or more first binaural signals as mentioned above, and the apparatus for generating two or more binaural signals as mentioned above.

According to another embodiment, a method for processing two or more first binaural signals may have: conducting a weighted mixing of the two or more first binaural signals to obtain a combined binaural signal, wherein the two or more first binaural signals are two or more binaural audio signals for different rotations of a same audio scene.

Another embodiment may have a method for generating two or more binaural signals, wherein the method has generating the two or more binaural signals being two or more binaural audio signals for different rotations of a same audio scene.

Another embodiment may have a non-transitory computer-readable medium having a computer program for implementing the above method for processing two or more first binaural signals or the above method for generating two or more binaural signals when being executed on a computer or signal processor.

Another embodiment may have an apparatus for generating signal prediction information, wherein the apparatus is configured to receive pose information and/or rotational offset information, wherein the apparatus is configured to generate a first binaural signal for a first rotation of an audio scene, and wherein the apparatus is configured to generate the signal prediction information depending on the pose information and/or the rotational offset information, such that one or more further binaural signals for one or more further rotations, being different from the first rotation, can be generated using the first binaural signal and using the signal prediction information.

Another embodiment may have an apparatus for generating one or more further binaural signals from a first binaural signal using signal prediction information, wherein the apparatus is configured to receive the first binaural signal for a first rotation of an audio scene, wherein the apparatus is configured to receive signal prediction information which depends on pose information and/or which depends on rotational offset information, and wherein the apparatus is configured to generate the one or more further binaural signals for one or more further rotations, being different from the first rotation using the first binaural signal and using the signal prediction information.

According to another embodiment, a system may have: one or more the apparatuses for generating one or more further binaural signals from a first binaural signal using signal prediction information as mentioned above, and the apparatus for generating signal prediction information as mentioned above.

According to another embodiment, a method for generating signal prediction information may have: receiving pose information and/or rotational offset information, and generating a first binaural signal for a first rotation of an audio scene, wherein generating the signal prediction information is conducted depending on the pose information and/or the rotational offset information, such that one or more further binaural signals for one or more further rotations, being different from the first rotation, can be generated using the first binaural signal and using the signal prediction information.

According to another embodiment, a method for generating one or more further binaural signals from a first binaural signal using signal prediction information may have: receiving the first binaural signal for a first rotation of an audio scene, receiving signal prediction information which depends on pose information and/or which depends on rotational offset information, and generating the one or more further binaural signals for one or more further rotations, being different from the first rotation using the first binaural signal and using the signal prediction information.

Another embodiment may have a non-transitory computer-readable medium having a computer program for implementing the above method for generating signal prediction information or the above method for generating one or more further binaural signals from a first binaural signal using signal prediction information when being executed on a computer or signal processor.

An apparatus for processing two or more first binaural signals according to an embodiment is provided. The apparatus comprises an audio processor configured for conducting a weighted mixing of the two or more first binaural signals to obtain a combined binaural signal. The two or more first binaural signals are two or more binaural audio signals for different rotations of a same audio scene.

Moreover, an apparatus for generating two or more binaural signals according to an embodiment is provided. The apparatus is configured for generating the two or more binaural signals being two or more binaural audio signals for different rotations of a same audio scene.

Furthermore, a method for processing two or more first binaural signals according to an embodiment is provided. The method comprises conducting a weighted mixing of the two or more first binaural signals to obtain a combined binaural signal. The two or more first binaural signals are two or more binaural audio signals for different rotations of a same audio scene.

Moreover, a method for generating two or more binaural signals according to an embodiment is provided. The method comprises generating two or more binaural signals being two or more binaural audio signals for different rotations of a same audio scene.

Furthermore, a computer program for implementing one of the above-described methods when being executed on a computer or signal processor is provided.

According to an embodiment, an audio processor for providing a binaural signal is provided, wherein the binaural signal is generated by a weighted mixing of two or more binaural signals, which comprise/relate to a spatial scene at different rotations (e.g., in a same scene, a different head pose may, e.g., be applied during rendering). In the AR/VR context, rendering media based on the user's pose is crucial in attaining a high quality of immersion. Depending on the system configuration, a lightweight, wearable device may offload tracked rendering to another device via transmission of a user pose. In such a scenario, the round-trip delay of the link can result in a rendered scene arriving with an outdated user pose, degrading the quality of the immersive experience.

Embodiments achieve correction/improvement of an outdated pose by pose correction.

According to embodiments, a low-complexity method for pose correction is provided, which can be applied directly on the lightweight device to mitigate this effect. The lightweight device may, e.g., dynamically determine the pose offset and may, e.g., be able to dynamically determine the signals transmitted by a capable device via a back-channel. The capacity for pose correction on the lightweight device enables an increase in the quality of the immersive experience.

According to embodiments, two properties of binaural rendering and binaurally rendered signals may, e.g., be employed to obtain a signal which approximates the binaural scene at a different rotations, for example, using a time-domain only processing.

In accordance with embodiments of the present application, the apparatus is configured to determine, for example, as a part of information about the pose of the head of the user, yaw angle information, for example, an angle value or a rotation matrix or a quaternion, describing an angle between a head front direction of the head of the user and the front direction of the coordinate system used by the audio processor performing the binaural rendering of the first binaural signals; and/or pitch angle information, for example, an angle value or a rotation matrix or a quaternion, describing a pitch angle of the head of the user, e.g. with respect to a horizontal alignment; and/or roll angle information, for example, an angle value or a rotation matrix or a quaternion describing a roll angle of the head of the user, e.g., with respect to a vertical direction, e.g. with respect to a direction of gravity.

According to another embodiment, an apparatus for generating signal prediction information is provided. The apparatus is configured to receive pose information and/or rotational offset information. Moreover, the apparatus is configured to generate a first binaural signal for a first rotation of an audio scene. Furthermore, the apparatus is configured to generate the signal prediction information depending on the pose information and/or the rotational offset information, such that one or more further binaural signals for one or more further rotations, being different from the first rotation, can be generated using the first binaural signal and using the signal prediction information.

According to a further embodiment, an apparatus for generating one or more further binaural signals from a first binaural signal using signal prediction information is provided. The apparatus is configured to receive the first binaural signal for a first rotation of an audio scene. Moreover, the apparatus is configured to receive signal prediction information which depends on pose information and/or which depends on rotational offset information. Furthermore, the apparatus is configured to generate the one or more further binaural signals for one or more further rotations, being different from the first rotation using the first binaural signal and using the signal prediction information.

According to another embodiment, a method for generating signal prediction information is provided. The method comprises:
Receiving pose information and/or rotational offset information. And:
Generating a first binaural signal for a first rotation of an audio scene.

Generating the signal prediction information is conducted depending on the pose information and/or the rotational offset information, such that one or more further binaural signals for one or more further rotations, being different from the first rotation, can be generated using the first binaural signal and using the signal prediction information.

In another embodiment, a method for generating one or more further binaural signals from a first binaural signal using signal prediction information is provided. The method comprises:
Receiving the first binaural signal for a first rotation of an audio scene.
Receiving signal prediction information which depends on pose information and/or which depends on rotational offset information. And:
Generating the one or more further binaural signals for one or more further rotations, being different from the first rotation using the first binaural signal and using the signal prediction information.

Furthermore, a computer program for implementing one of the above-described methods when being executed on a computer or signal processor is provided.

### BRIEF DESCRIPTION OF THE DRAWINGS

In the following, embodiments of the present invention are described in more detail with reference to the figures, in which:

FIG. 1 illustrates an apparatus for processing two or more first binaural signals according to an embodiment;

FIG. 2 illustrates a system with a delay in head pose transmission between a lightweight device and a capable device;

FIG. 3 illustrates a system with a delay in head pose transmission over a link between a lightweight device with an audio decoder and a capable device with an audio encoder;

FIG. 4 illustrates an approximation of 180° rotation via a binaural channel swap;

FIG. 5 illustrates a system for pose correction using multiple time domain signals according to an embodiment;

FIG. 6 illustrates a system for pose correction using multiple time domain signals, wherein the capable device of the system comprises an audio encoder and wherein the lightweight device of the system comprise an audio decoder;

FIG. 7 illustrates a top-down view of a scene with a yaw angle for the case of θ=30° according to an embodiment;

FIG. 8 illustrates an apparatus for pose correction of the yaw axis implementing a pose correction algorithm according to an embodiment;

FIG. 9 illustrates an apparatus for complete pose correction implementing a pose correction algorithm for the generic case according to an embodiment;

FIG. 10 illustrates an apparatus according to an embodiment for yaw correction;

FIG. 11 illustrates an apparatus for a yaw correction according to an embodiment comprising an audio decoder;

FIG. 12 illustrates an apparatus for complete pose correction according to an embodiment;

FIG. 13 illustrates an apparatus according to an embodiment for complete pose correction with an audio decoder;

FIG. 14 illustrates a flow chart which depicts a communication flow between a capable device and a lightweight device according to a particular embodiment, wherein the capable device receives a data stream or a signal, e.g., from a network entity;

FIG. 15 illustrates first listening test results indicating the averages and the 95% confidence intervals for twelve items;

FIG. 16 illustrates a head with depicted yaw, pitch and roll axes; and

FIG. 17 illustrates a system comprising an apparatus for generating signal prediction information according to an embodiment, and an apparatus for generating one or more further binaural signals from a first binaural signal.

### DETAILED DESCRIPTION OF THE INVENTION

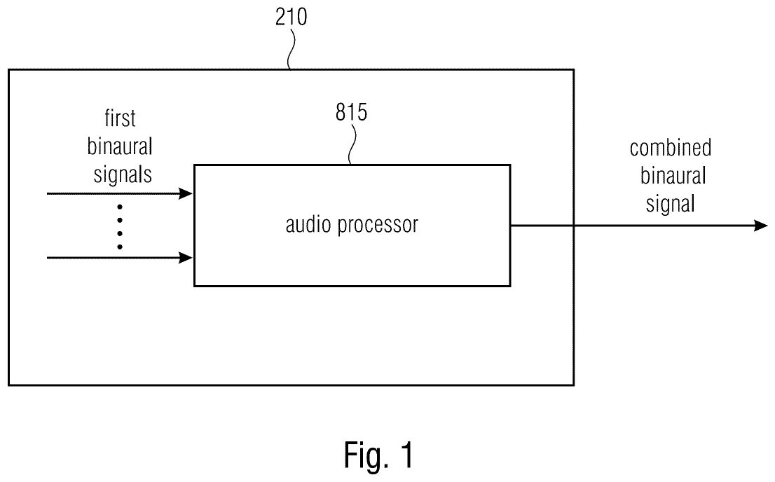

FIG. 1 illustrates an apparatus 210 for processing two or more first binaural signals according to an embodiment.

The apparatus 210 comprises an audio processor 815 configured for conducting a weighted mixing of the two or more first binaural signals to obtain a combined binaural signal.

The two or more first binaural signals are two or more binaural audio signals for different rotations of a same audio scene.

According to an embodiment, the different rotations may, e.g., indicate different head poses of a head within the audio scene, such that the two or more first binaural signals are associated with the different head poses of the head.

In an embodiment, the different head poses of the head may, e.g., be defined with respect to one or more Euler angles. And/or, the different head poses of the head may, e.g., be defined with respect to at least one of a yaw angle and a pitch angle and a roll angle. And/or the different head poses of the head may, e.g., be defined with respect to a rotation matrix. And/or, the different head poses of the head may, e.g., be defined with respect to one or more quaternions.

According to an embodiment, each of the two or more first binaural signals is associated with an associated absolute pose P′₁ . . . P′_{N} being different from the associated absolute pose P′₁ . . . P′_{N} of any other one of the two or more first binaural signals. And/or, each of the two or more first binaural signals may, e.g., be associated with an associated relative rotational offset k₁ . . . k_{N} being different from the associated relative rotational offset k₁ . . . k_{N} of any other one of the two or more first binaural signals. In embodiments, the associated relative rotational offsets k₁ . . . k_{N} may, e.g., depend on θ.

An example for associated relative rotational offsets defined for a single rotation axis is, for example, k₁=−50°; k₂=−25°; k₃=0°; k₄=25°; k₅=50°. A corresponding example for corresponding associated absolute poses defined for said single rotation axis is, for example, P′₁=30°; P′₂=55°; P′₃=80°; P′₄=105°; P′₅=130°.

It should be noted that associated relative rotational offsets k₁ . . . k_{N} and/or associated absolute poses may, e.g., also be defined for two or more rotation axes, e.g., three rotation axes. In these cases, an associated relative rotational offset k₁ . . . k_{N} and/or an associated absolute pose may, e.g., be defined as a vector of angles, as a rotation matrix or as a quaternion.

Regarding the associated relative rotational offset k₁ . . . K_{N}, later on, a value θ (a rotational offset parameter) will be described. In some embodiments, the associated relative rotational offset may, e.g., depend on said value. In the examples below, for example, transmitting the value θ from a lightweight device 210 to a capable device 220 may, e.g., cause the capable device 220 to generate, for example, three binaural signals, a first one, being associated with the associated relative rotational offset θ, a second one, being associated with the associated relative rotational offset θ, and a third one, being associated with the associated relative rotational offset −θ.

Any other number of binaural signals may, e.g., be generated in response to receiving θ. Moreover, in response to receiving θ, other binaural signals may, e.g., be generated by the capable device, for example, five binaural signals associated with the relative rotational offsets, −3 θ; −1.5 θ; 0; +1.5 θ; and 3 θ. Any other examples are likewise possible. In some embodiments, for a value θ, a number of binaural signals associated with k₁(θ) . . . k_{N}(θ) may, e.g., be received by the apparatus 210, with kᵢ being a function which maps θ on a value.

According to an embodiment, the apparatus 210 may, e.g., be configured to receive information on the associated absolute pose P′₁ . . . P′_{N} of the two or more first binaural signals and/or information on the associated relative rotational offset k₁ . . . k_{N} of the two or more first binaural signals, e.g., from another apparatus 220.

In an embodiment, the associated absolute pose P′₁ . . . P′_{N} may, e.g., be associated with each of the two or more first binaural signals indicates the head pose of the head, being defined depending on the one or more Euler angles and/or the yaw angle and/or the pitch angle and/or the roll angle and/or the rotation matrix and/or the one or more quaternions. And/or, the associated relative rotational offset k₁ . . . k_{N} may, e.g., be associated with each of the two or more first binaural signals indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

According to an embodiment, the associated absolute pose P′₁ . . . P′_{N} being associated with each of the two or more first binaural signals may, e.g., indicate a head pose of a head, being defined depending on at least one of a yaw axis and a pitch axis and a roll axis of the head. The rotational offset being associated with each of the two or more first binaural signals may, e.g., indicate a difference of a second head pose of the head with respect to a first head pose of the head, being defined depending on at least one of the yaw axis and the pitch axis and the roll axis of the head.

In an embodiment, the audio processor 815 may, e.g., be configured to conduct the weighted mixing depending on one or more weights g₁ . . . g_{N}. The audio processor 815 may, e.g., be configured to determine the one or more weights g₁ . . . g_{N} depending on the associated absolute pose P′₁ . . . P′_{N} or the associated relative rotational offset k₁ . . . k_{N} being associated with each of the two or more first binaural signals, and depending on a current rotational offset ΔP between a current pose P and a previous pose P′, wherein the current rotational offset ΔP indicates the at least one difference between the current rotation angle and the previous rotation angle with respect to a rotation axis (for example, with respect to the yaw axis or the pitch axis or a roll axis).

It should be noted that the audio processor 815 may, e.g., determine that one or some of the weights g₁ . . . g_{N} shall be set to 0.

According to an embodiment, the audio processor 815 may, e.g., be configured to determine the one or more weights g₁ . . . g_{N} by determining a weight g₁ . . . g_{N} for each binaural signal of the two or more first binaural signals, such that the weight for the binaural signal depends on a difference between the current rotational offset ΔP and the associated relative rotational offset k₁ . . . k_{N} being associated with the binaural signal.

In an embodiment, the audio processor 815 may, e.g., be configured to receive three or more binaural input signals, each of which being associated with an associated absolute pose P′₁ . . . P′_{N} or an associated relative rotational offset k₁ . . . k_{N}. To obtain the two or more first binaural audio signals, the audio processor 815 may, e.g., be configured to select at least two selected binaural signals of the three or more binaural input signals depending on the current rotational offset ΔP and depending on the associated absolute pose P′₁ . . . P′_{N} or the associated relative rotational offset k₁ . . . k_{N} of each of the three or more binaural input signals.

According to an embodiment, the audio signal processor 815 may, e.g., be configured to determine whether to swap the two audio channels of a binaural signal of the at least two selected binaural signals with each other, depending on the current rotational offset ΔP and depending on the associated absolute pose P′₁ . . . P′_{N} or the associated relative rotational offset k₁ . . . k_{N} being associated with the binaural signal. The audio signal processor 815 may, e.g., be configured, if it has been determined that the two audio channels shall be swapped, the audio signal processor 815 may, e.g., be configured to swap the two audio channels of the binaural signal with each other to obtain one of the two or more first binaural signals.

In an embodiment, a first signal processor and a second signal processor may, e.g., together form the audio signal processor 815. The first signal processor may, e.g., be configured to receive a first channel of three or more binaural input signals, each of which being associated with an associated absolute pose P′₁ . . . P′_{N} or an associated relative rotational offset k₁ . . . k_{N}. To obtain a first channel of each of the two or more first binaural audio signals, the first signal processor may, e.g., be configured to select at least two selected binaural signals of the three or more binaural input signals depending on the current rotational offset ΔP and depending on the associated absolute pose P′₁ . . . P′_{N} or the associated relative rotational offset k₁ . . . k_{N} of each of the three or more binaural input signals; wherein the first signal processor is configured to conduct a weighted mixing of the first channel of each two or more first binaural signals to obtain a first channel of the combined binaural signal. To obtain a second channel of each of the two or more first binaural audio signals, the second signal processor is configured to select at least two selected binaural signals of the three or more binaural input signals depending on the current rotational offset ΔP and depending on the associated absolute pose P′₁ . . . P′_{N} or the associated relative rotational offset k₁ . . . k_{N} of each of the three or more binaural input signals; wherein the second signal processor is configured to conduct a weighted mixing of the second channel of each two or more first binaural signals to obtain a second channel of the combined binaural signal.

In an embodiment, the first signal processor and the second signal processor may, e.g., be spaced from each other.

According to an embodiment, the apparatus 210 may, e.g., comprise a pair of two earbuds, wherein the first signal processor may, e.g., be implemented in a first one of the two earbuds, and wherein the second signal processor may, e.g., be implemented in a second one of the two earbuds.

In an embodiment, the apparatus 210 may, e.g., be configured to obtain two or more binaural input signals from one or more transmissions of another apparatus 220.

According to an embodiment, the transmission may, e.g., comprise the two or more binaural input signals being represented in a time domain. Or, the transmission may, e.g., comprise the two or more binaural input signals being represented in a frequency domain. Or, the transmission may, e.g., comprise an encoding of the two or more binaural input signals being represented in the time domain or in the frequency domain.

According to an embodiment, the apparatus (210) and the further apparatus (220) may, e.g., be connected via a link with a delay, for example, a wireless link.

In an embodiment, at least one of the two or more binaural input signals may, e.g., depend on a rotational offset parameter θ and is associated with an associated absolute pose P′₁ . . . P′_{N} or with an associated relative rotational offset k₁ . . . k_{N}, which depends on the rotational offset parameter θ. Each of the two or more first binaural signals may, e.g., correspond to one of the two or more binaural input signals or is derived from one of the two or more binaural input signals.

In an embodiment, the apparatus may, e.g., be configured to transmit the rotational offset parameter θ to another apparatus 220. The apparatus 210 may, e.g., be configured to receive the transmission from the other apparatus 220 comprising the two or more binaural input signals or an encoding thereof.

According to an embodiment, the apparatus 210 may, e.g., be configured to determine the rotational offset parameter θ depending on the current rotational offset ΔP; and/or the apparatus 210 may, e.g., be configured to determine the rotational offset parameter θ depending on a link latency.

In general, according to a particular embodiment, if the link latency is greater, usually, θ will be set greater, as due to the greater/larger latency, it can be expected that during transmission latency, a larger movement/rotational offset, e.g., of a head, will occur, compared to a situation, where the latency is smaller.

In an embodiment, the apparatus 210 may, e.g., be configured to receive or to (e.g., dynamically) determine information on a link latency of the transmission. Moreover, the apparatus 210 may, e.g., be configured to perform pose prediction depending on the link latency.

In an embodiment, the apparatus 210 may, e.g., be configured to transmit the current rotational offset ΔP and/or one or more poses P₁ . . . P_{N} and/or upstream metadata to another apparatus 220.

In an embodiment, the apparatus 210 may, e.g., be configured to receive the transmission from the other apparatus 220 comprising the two or more binaural input signals or an encoding thereof. The apparatus 210 may, e.g., be configured to receive the rotational offset parameter θ from the other apparatus 220. The apparatus 210 may, e.g., be configured to determine the two or more first binaural signals from the two or more binaural input signals depending on the current rotational offset ΔP; or may, e.g., be configured to determine the one or more weights g₁ . . . g_{N} depending on the current rotational offset ΔP.

According to an embodiment, the apparatus 210 may, e.g., be configured to determine the two or more first binaural signals from the two or more binaural input signals or is configured to determine the one or more weights g₁ . . . g_{N} by employing a linear panning or by employing a tangent panning or by employing Vector Base Amplitude Panning or by employing Edge Fading Amplitude Panning or by employing ambisonic panning or quaternion based panning.

According to an embodiment, the apparatus 210 may, e.g., be configured to receive the transmission from the other apparatus 220 comprising a number of one or more transmitted binaural signals or an encoding thereof and metadata, the number being smaller than the number of the two or more binaural input signals. The apparatus 210 may, e.g., be configured to obtain the two or more binaural input signals from the transmission by reconstructing the two or more binaural input signals from the one or more transmitted binaural signals using the metadata.

In an embodiment, the transmission comprises one or more parametric or model-based head-related transfer functions and/or acoustic parameters, or an encoding thereof. The apparatus 210 may, e.g., be configured to obtain the two or more binaural input signals using the one or more parametric model-based head-related transfer functions and/or the acoustic parameters.

According to an embodiment, the audio processor 815 may, e.g., be configured to obtain one or more additional binaural signals from the two or more binaural input signals by modifying binaural cues of at least one of the two or more binaural input signals. The audio processor 815 may, e.g., be configured to obtain the two or more first binaural signals from the two or more binaural input signals and from the one or more additional binaural signals.

In an embodiment, the apparatus 210 may, e.g., comprise a pose offset module 810 for determining the current rotational offset ΔP between the current pose P and the previous pose P′, wherein the current rotational offset ΔP indicates the at least one difference between the current rotation angle and the previous rotation angle with respect to a rotation axis.

According to an embodiment, the audio processor 815 may, e.g., be configured to conduct the weighted mixing of the two or more first binaural signals in a time domain. Or, the audio processor 815 may, e.g., be configured to conduct the weighted mixing of the two or more first binaural signals in the frequency domain.

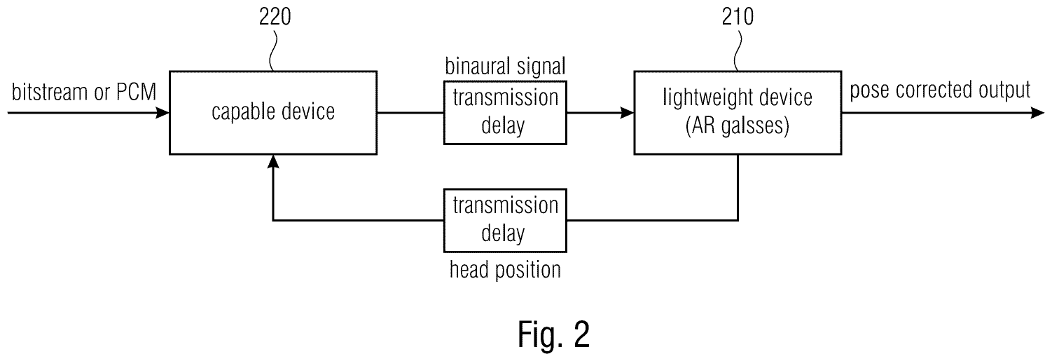

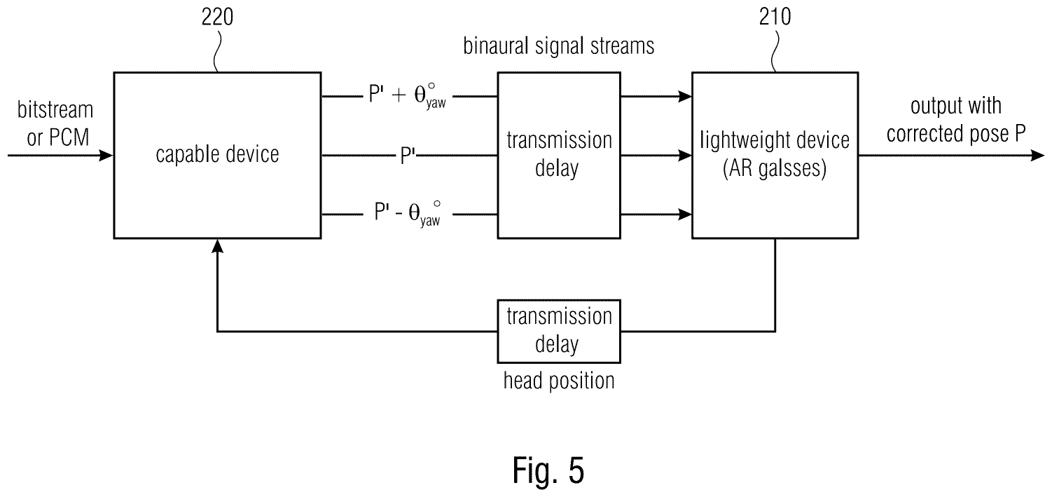

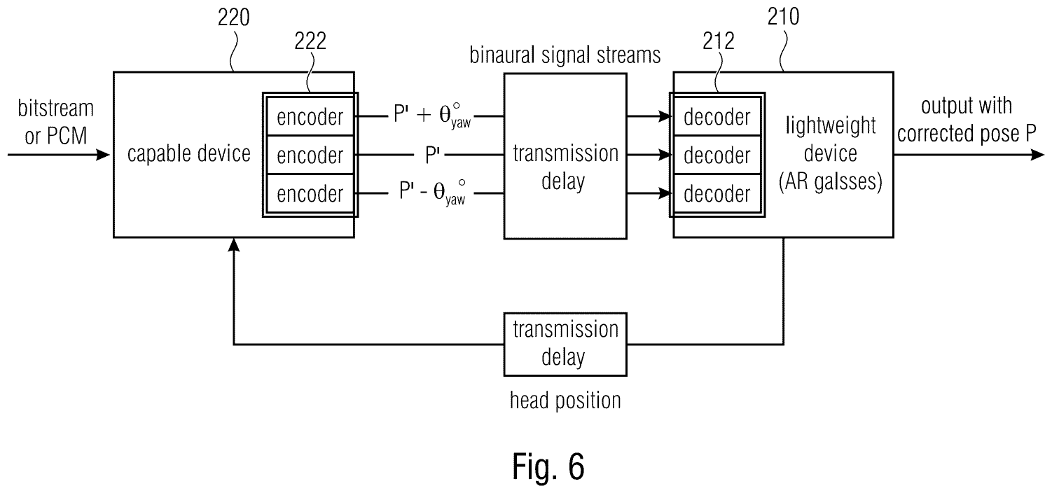

Moreover, an apparatus 220 for generating two or more binaural signals according to an embodiment is provided (see, for example, FIG. 2, FIG. 5 or FIG. 6).

The apparatus 220 is configured for generating the two or more binaural signals being two or more binaural audio signals for different rotations of a same audio scene.

According to an embodiment, the different rotations may, e.g., indicate different head poses of a head within the audio scene, such that the two or more binaural signals are associated with the different head poses of the head.

In an embodiment, the different head poses of the head may, e.g., be defined with respect to one or more Euler angles. And/or, the different head poses of the head may, e.g., be defined with respect to at least one of a yaw angle and a pitch angle and a roll angle. And/or, the different head poses of the head may, e.g., be defined with respect to a rotation matrix. And/or, the different head poses of the head may, e.g., be defined with respect to one or more quaternions.

According to an embodiment, each of the two or more binaural signals may, e.g., be associated with an associated absolute pose P′₁ . . . P′_{N} being different from the associated absolute pose P′₁ . . . P′_{N} of any other one of the two or more binaural signals. And/or, each of the two or more binaural signals may, e.g., be associated with an associated relative rotational offset k₁ . . . k_{N} being different from the associated relative rotational offset k₁ . . . k_{N} of any other one of the two or more binaural signals.

In an embodiment, the apparatus 220 may, e.g., be configured to transmit information on the associated absolute pose P′₁ . . . P′_{N} of the two or more binaural signals and/or information on the associated relative rotational offset k₁ . . . k_{N} of the two or more binaural signals, e.g., to another apparatus 210.

According to an embodiment, the associated absolute pose P′₁ . . . P′_{N} being associated with each of the two or more binaural signals may, e.g., indicate the head pose of the head, being defined depending on the one or more Euler angles and/or the yaw angle and/or the pitch angle and/or the roll angle and/or the rotation matrix and/or the one or more quaternions. And/or, the associated relative rotational offset k₁ . . . k_{N} being associated with each of the two or more binaural signals may, e.g., indicate a difference of a second head pose of the head with respect to a first head pose of the head, being defined depending on the one or more Euler angles and/or the yaw angle and/or the pitch angle and/or the roll angle and/or the rotation matrix and/or the one or more quaternions.

In an embodiment, the apparatus 220 may, e.g., be configured to conduct one or more transmissions to transmit the two or more binaural signals to a further apparatus 210.

According to an embodiment, the transmission may, e.g., comprise the two or more binaural input signals being represented in a time domain. Or, the transmission may, e.g., comprise the two or more binaural input signals being represented in a frequency domain. Or, the transmission may, e.g., comprise an encoding of the two or more binaural input signals being represented in the time domain or in the frequency domain.

According to an embodiment, the apparatus 220 and the further apparatus 210 may, e.g., be connected via a link with a delay, for example, a wireless link.

In an embodiment, at least one of the two or more binaural signals may, e.g., depend on a rotational offset parameter θ and is associated with an associated absolute pose P′₁ . . . P′_{N} or with an associated relative rotational offset k₁ . . . k_{N}, which depends on the rotational offset parameter θ.

According to an embodiment, the apparatus 220 may, e.g., be configured to receive the rotational offset parameter θ from another apparatus 210. The apparatus 220 may, e.g., be configured to transmit the two or more binaural signals or an encoding thereof to the other apparatus 210.

In an embodiment, the rotational offset parameter θ may, e.g., depend on a current rotational offset ΔP.

In an embodiment, the apparatus 220 may, e.g., be configured to receive or to, e.g., dynamically, determine information on a link latency of the transmission. The apparatus 220 may, e.g., be configured to perform pose prediction depending on the link latency. Pose prediction may, e.g., be employed to minimize ΔP.

According to an embodiment, the apparatus 220 may, e.g., be configured to receive a current rotational offset ΔP and/or one or more poses P′₁ . . . P′_{N} and/or upstream metadata from another apparatus 210. Moreover, the apparatus 220 may, e.g., be configured to determine the rotational offset parameter θ using the current rotational offset ΔP and/or using the one or more poses P′₁ . . . P′_{N} and/or using the upstream metadata.

According to an embodiment, the apparatus 220 may, e.g., be configured to transmit the two or more binaural signals or an encoding thereof to the other apparatus 210. The apparatus 220 may, e.g., be configured to transmit the rotational offset parameter θ to the other apparatus 210.

Moreover, a system is provided. The system comprises one or more apparatuses 210 according to one of the above-described embodiments, e.g., the lightweight device, and the apparatus 220 of one of the above-described embodiments, e.g., the capable device.

In the following, some background considerations for some of the embodiments are described.

Today's Augmented Reality/Virtual Reality devices, for example, in the form of glasses or earbuds, aim at small form factors and reduced weight, to be comfortable to wear. This however comes with limitations in processing power and battery capacity. A potential solution to this problem is to split the processing between two devices:

The first device 210 may, e.g., be referred to as a lightweight device 210, for example, a battery-powered device worn by a user (e.g., AR glasses, earbuds), where pose tracking (e.g., by means of head tracking data) and only low-complexity processing is carried out.

The second device 220 may, e.g., be referred to as a capable device 220, for example, a smartphone or an edge device, where the complexity intensive processing is carried out. This includes typically media decoding (audio, video) and a pose adaption of the content (e.g., scene rotation).

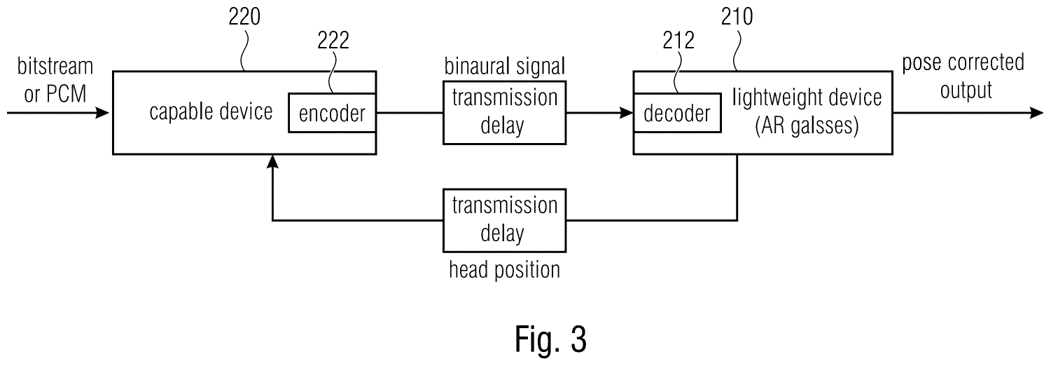

For example, FIG. 2, FIG. 3, FIG. 5 and FIG. 6 illustrate a system comprising a first device 210 (e.g., a lightweight device) and a second device 220 (e.g., a capable device).

Both devices, the first device 210 (e.g., the lightweight device) and the second device (e.g., the capable device) are connected via a link, e.g., a link with a delay, for example, via a wireless link that may, e.g., be limited in bitrate and in addition includes transmission delay.

Such a setup introduces a latency between the pose tracking on the lightweight device 210 and the pose adaption on the capable device 220. A way to deal with this problem, for example, for audio signals and/or for video signals, may, for example, to proceed as follows:

An estimation of the latency of the pose on the lightweight device 210 may, e.g., be performed, for example, by measuring the motion-to-sound latency or the round-trip delay of sending the pose from the lightweight device 210 to the capable device 220 and, for example, by analyzing the pose actually used for rendering the current media. This round-trip delay may e.g., be in the range of 50 ms-200 ms.

Another way of estimating the latency of the pose on the lightweight device 210 may, e.g., be performed, for example, by attaching a timestamp or an identifier to the pose, which also gets transmitted back (with the binaurally rendered audio) to the lightweight device.

A predicted pose may, e.g., be estimated on the lightweight device 210 based on the actual pose, where the predicted pose depends on/corresponds to the round-trip delay.

On the capable device 220, media decoding and a pose adaption of the content to the predicted pose (e.g., referred to as pre-rendering) may, e.g., be carried out.

The pre-rendered data/pre-rendered scene may, e.g., then be transmitted to the lightweight device 210.

On the lightweight device 210, the pose may then, e.g., be corrected according to the actual pose at the time of playout.

Some embodiments relate to audio aspects and may, for example, relate to the rendering of an immersive scene to stereo headphones.

According to some embodiments, an immersive audio signal (e.g., binaural audio, and/or e.g., audio objects, and/or, e.g., multi-channel audio, and/or, e.g., Ambisonics audio) may, for example, be assumed to be binaurally rendered according to a head pose, for example, estimated at the lightweight device 210, and/or, for example, transmitted from the capable device 220 to the lightweight device 210.

Possible links may, e.g., comprise, for example, Wi-Fi and Bluetooth and corresponding audio codecs such as LC3. Other wireless technologies may, e.g., be used for connecting the capable device 220 and lightweight device 210, such as 5G, including 5G Sidelink, UWB (Ultra Wideband), LTE, etc.

The predicted head pose information may, for example, be sent over a backlink to the capable device 220 which may, e.g., render the binaural signal. In both the transmission of the binaural signal and the head pose data, a transmission delay is involved which comprises a delay from the wireless connection such as propagation times and also other sources of delay such as the delay of audio codecs. It is known to experts in the fields that audio codecs typically come with some algorithmic delay that is inherent to the codec algorithm.

FIG. 2 illustrates a system with a delay in head pose transmission between a lightweight device 210 and a capable device 220.

FIG. 3 illustrates a system with a delay in head pose transmission over a link between a lightweight device 210 with an audio decoder 212 and a capable device 220 with an audio encoder 222.

Since the rendering device uses the pose data transmitted over the backlink to render a binaural signal, by the time this signal reaches the lightweight device 210, the user's head pose will most probably have changed, causing the binaural cues to be incorrect. In practice, this delay is expected to typically lie between 50 ms and 200 ms.

This evokes the need for a low-complexity and low-latency solution which can be utilized directly on the lightweight device 210 to perform a pose update to compensate for any deviation in the head pose. The solutions of the known technology in [1] and [2] presented above rely on a filter bank or transform to obtain a frequency domain representation to enable a band-wise processing which allows either a cue-to-direction codebook to be applied as in [1] or a covariance-based processing as in [2]. In the known technology, the requirement of a frequency domain representation introduces a certain framing delay in addition to computational complexity for performing the transform and inverse transform.

It would be an option for a time-domain approach to transmit two signals at e.g. two poses spanning the expected deviation of a pose during the link latency and to perform an interpolation between them. Such an approach should allow interpolation over a vector joining the two poses. If the two poses are either side of the rendered delayed pose, a linear interpolation at the center would average both. With a large pose offset, this averaging can lead to a spatial collapse, where two signals with effectively mirrored binaural cues are averaged. This can degrade the quality significantly and thus transmission of the delayed pose with is used to maintain quality. With a smaller pose offset, the two signal approach may be of reasonable quality.

Moreover, an another alternative approach would be to use a covariance based approach. Using such a concept, e.g., for the yaw axis, the signal may, e.g., be rendered with poses of P′+15° and P′−15°, i.e. with relative rotation offsets of ±15° on the yaw axis. The signal may, e.g., also be rendered at delayed pose P′, as it would be the case with no pose correction. This may, e.g., be followed by a computation of a prediction matrix per band for each pair of signals i.e. P′, P′+15° and', P′−15°. This prediction matrix estimates the signal in each band at P′±15° given the signal at P′.

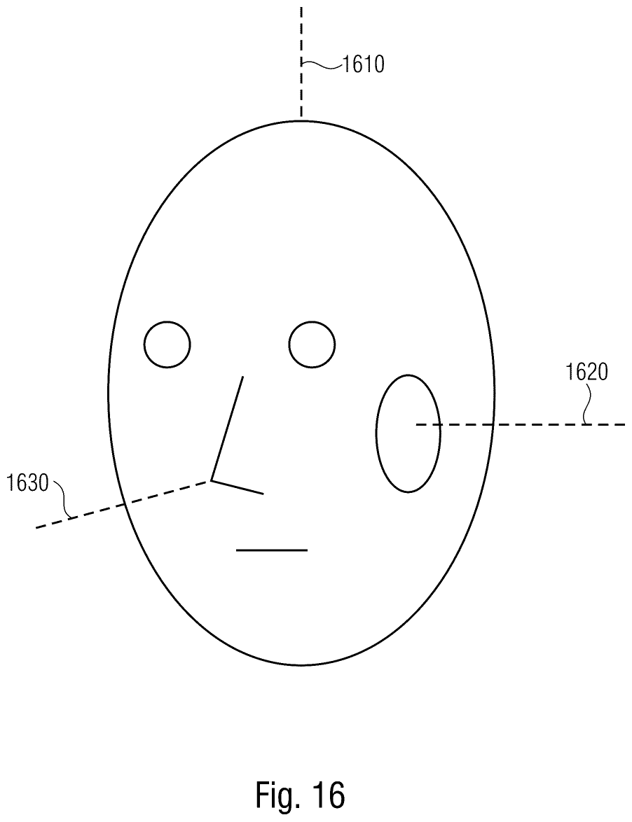

FIG. 16 illustrates a head, wherein the yaw axis 1610, the pitch axis 1620 and the roll axis 1630 are depicted.

The rendering of the binaural signal at P′ may, e.g., be transmitted along with two sets of band-wise prediction matrices as metadata to the lightweight device 210 which determines the actual pose offset between delayed and latest pose ΔP=P−P′ and applies an interpolation factor on the relevant set of band-wise matrices to obtain an approximation of the latest pose P. This approach works quite well when the pose offset ΔP lies in the expected range, but can produce undesirable artefacts once it moves outside this range, even leading to degradations in quality compared to no correction of pose.

Regarding bilinear interpolation on a set of impulse responses to obtain an interpolated response for a missing position see, e.g., [3], referred to above.

In the following, particular embodiments are described.

At first, HRTF interpolation and binaural rendering via convolution according to embodiments is described.

The weights for such a bilinear interpolation may also be determined by loudspeaker panning methods, such as Vector Base Amplitude Panning, VBAP, (for example, as used in the Matlab interpolateHRTF() function), Edge Fading Amplitude Panning, EFAP, or tangent law panning for the linear case, etc.

According to embodiments, considering the linear case of a pair of impulse responses ir₁and ir₂, an interpolated impulse response irᵢₙₜₑᵣₚ along a line connecting the source positions of the two true responses ir and ir₂ may, e.g., be determined using panning gains w₁ and w₂:

$$i {r}_{interp} ( t ) = {w}_{1} i {r}_{1} ( t ) + {w}_{2} i {r}_{2} ( t )$$

A binaural rendering of a source signal x(t) using this (interpolated) impulse response irᵢₙₜₑᵣₚ may, e.g., be described by the equation:

$${y}_{interp} ( t ) = x ( t ) {ir}_{interp} ( t )$$

wherein \textcircled{*} is the convolution operation. Substituting irᵢₙₜₑᵣₚ(t) by the right side of the first equation results in:

$${y}_{interp} ( t ) = x ( t ) ( {w}_{1} i {r}_{1} ( t ) + {w}_{2} i {r}_{2} ( t ) )$$

Further, using the distributivity and linearity properties of convolution, the equation can be rearranged to:

$${y}_{iinterp} ( t ) = {w}_{1} [ x ( t ) {ir}_{1} ( t ) ] + {w}_{2} [ x ( t ) {ir}_{2} ( t ) ]$$

Thus, a convolution of a signal with a weighted summation of impulse responses is equivalent to a weighted summation of the same signal independently convolved with the two impulse responses.

Considering a multi-source binaural signal y(t)=Σₙxₙ(t)\textcircled{*}irₙ(t), an interpolated rotation may also be approximated by a weighted summation of this multi-source signal at two different rotations.

In the following, an approximation of a 180° rotation on the horizontal plane according to embodiments is described.

A binaural representation of a sound scene comprises directional cues which help with the localization of sources. If the two channels of a binaural signal are swapped, the resulting signal has interchanged localization cues for both ears. This mimics the scenario where the head is rotated by 180° facing the opposite direction of the original scene. However, since the swapping does not account for the changes in spectral cues due to the shadowing (or lack of shadowing, depending on the source direction of arrival) of the ear pinna, the timbre of this approximation differs from the ground truth.

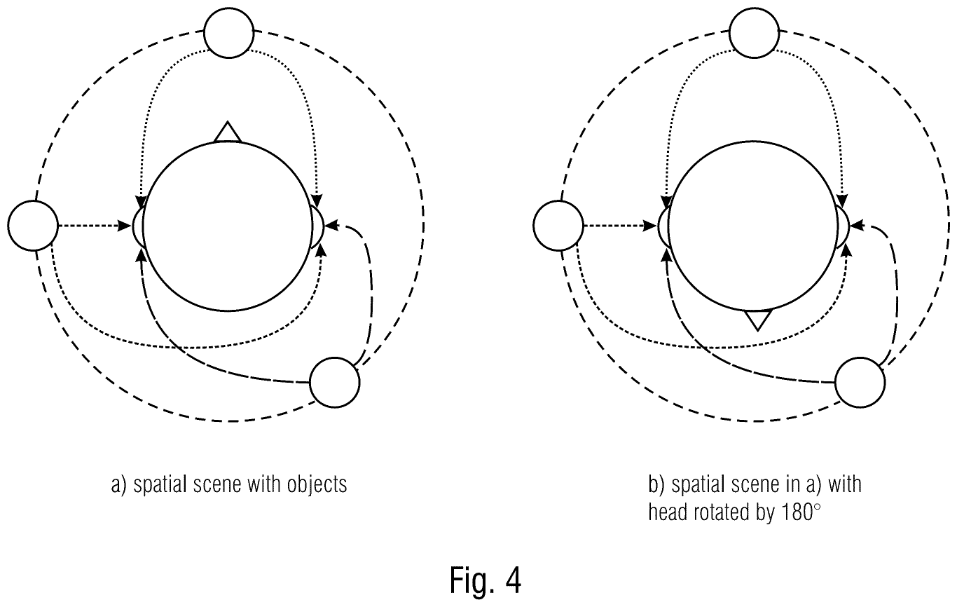

FIG. 4 illustrates an approximation of 180° rotation via a binaural channel swap.

In FIG. 4, it can be seen that for the case where the head is rotated by 180°, the ear signals are essentially interchanged. The only asymmetry is due to filtering from the pinna, apart from this the inter-aural level and time difference cues would be preserved with a channel swap. Thus, for a binaural signal y(t), it follows that y_{180°}(t)≈swap(y(t)). In other embodiments, the channel swap of a binaural signal for a given pose may, e.g., be employed to approximate a binaural signal for another pose, not necessarily rotated by 180° in yaw.

In the following, particular embodiments are described in more detail.

While the following explanations are provided with respect to θ_{yaw}°, it is noted that the explanations likewise apply to pitch, roll, to other Euler angles and to a rotation matrix and to (one or more) quaternions.

By transmitting a set of, e.g., three binaural signal pairs, any rotation on the yaw axis can be approximated by determining the offset of the latest pose with respect to the delayed pose and by performing an interpolation using one of the above techniques.

To accomplish this, the capable device 220 uses the delayed pose P′ received from a head tracker (e.g., in the lightweight device 210) and performs a rendering to three different head poses P′, P′+θ°_{yaw} and P′−θ°_{yaw} (where |θ|<90°, e.g.) 30° (For example, the selected offset of θ° may be adaptively determined based the recent head motion. In a particular embodiment, the signal with the scene rotated to −θ° may, for example, be substituted by a signal with the scene rotated to (180−θ°).

FIG. 5 illustrates a system for pose correction using multiple time domain signals according to an embodiment.

FIG. 6 illustrates a system for pose correction using multiple time domain signals, wherein the capable device 220 of the system comprises an audio encoder 222 and wherein the lightweight device 210 of the system comprises an audio decoder 212.

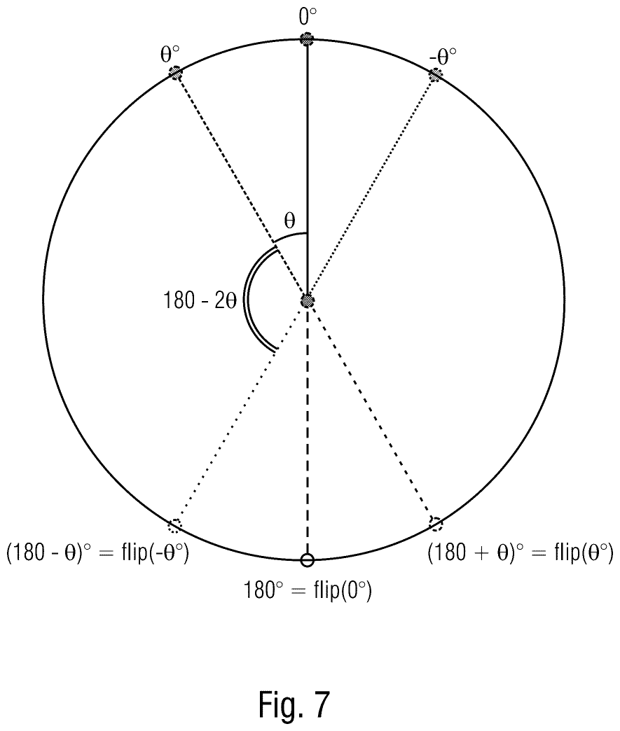

These three signals may, e.g., then be used on the split rendering device to perform, e.g., a signal pair selection and, e.g., optional channel swap based on the actual offset ΔP_{yaw} between the latest pose P and the delayed pose P′. This is visualized by FIG. 7.

FIG. 7 illustrates a top-down view of a scene with a yaw angle for the case of θ=30° according to an embodiment.

Based on the value of ΔP_{yaw}, panning gains are computed between the corresponding pair of signals, either using the unmodified transmitted signals at P′, (P′+θ_{yaw}°) and (P′−θ_{yaw}°) or the channel swapped versions at poses of (P′+)180°, P′+(180°−θ_{yaw}°) and P′+(180°+)θ_{yaw}°.

For a yaw-only pose correction, the gain computation is performed only on one dimension, thus a simple tangent panning law is sufficient. This may, e.g., include a selection of the signal pair in which ΔP lies and the corresponding panning aperture θ or 180°−2θ.

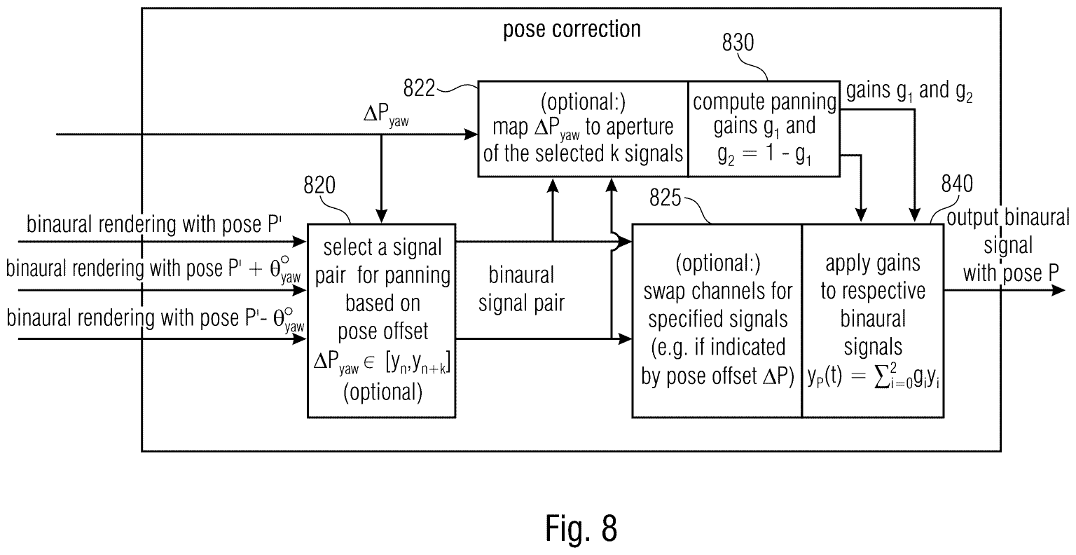

FIG. 8 illustrates an apparatus for pose correction of the yaw axis implementing a pose correction algorithm according to an embodiment.

For example, three binaural signals may, e.g., be received by selection module 820, e.g., a first binaural signal for the delayed pose, P′, a second binaural signal for P′+θ_{yaw}° and a third binaural signal for P′−θ_{yaw}°. For example, with θ_{yaw}°=30°, a first binaural signal is received for P′, a second binaural signal is received for P′+30° and a third binaural signal is received for P′−30°.

In this context, P′−θ_{yaw}°, P′, P′+θ_{yaw}° may, e.g., be referred to as the associated absolute poses of the three binaural signals, and−θ_{yaw}°, 0, θ_{yaw}° may, e.g., be referred to as the associated relative rotational offsets k₁ . . . k_{N} of the three binaural signals.

A pose offset ΔP may, e.g., indicate an offset between the latest pose P and the delayed pose P′: ΔP=P−P′. If only the yaw axis is considered, ΔP may, e.g., indicate a difference for the yaw axis. If also the pitch axis and/or the roll axis is considered, ΔP may, e.g., a difference for each of these axes. E.g., ΔP may, in these cases, for example, be a vector comprising two or three components.

In this context, P may, e.g., be referred to as a current pose, P′ may, e.g., be referred to as a previous pose, and ΔP may, e.g., be referred to as a current rotational offset.

Depending on the pose offset ΔP, a binaural signal pair may, e.g., be selected by selection module 820.

For example, the two binaural signals for pose offsets being closest to the calculated pose offset ΔP may, e.g., be selected. E.g., if ΔP=−20°, the binaural signals for P′, and P′−30° may, e.g., be selected, but not the binaural signal for P′+30°.

Or, for example, the (here: three) swapped channel versions of the received binaural signals may, e.g., also be taken into account for the selection. E.g., a first swapped binaural signal for (P′+) 180° may, e.g., be associated with the first binaural signal for P′; a second swapped binaural signal for P′+(180°−30°)=P′+150° may, e.g., be associated with the second binaural signal for P′+30°; and a third swapped binaural signal for P′+(180°+30°)=P′+210° may, e.g., be associated with the third binaural signal for P′−30°.

For example, if ΔP=+160°, the binaural signals for P′, and P′+30° may, e.g., be selected, but not the binaural signal for P′−30°, and then, a swapping of the two channels of each of the two selected binaural signals may, e.g., be conducted, e.g., by channel swapping module 825. However, if ΔP=+20°, the binaural signals for P′, and P′+30° may, e.g., also be selected, but no channel swapping is conducted in channel swapping module 825.

Optionally, a mapping module 822 may, e.g., map the current pose offset to the coordinate system of pose offsets of the selected binaural signals. If the current pose offset is (always) represented in the same coordinate system as the pose offsets of the two selected binaural signals, this is, e.g., not necessary. For example, a mapping from one coordinate system to another coordinate system may, e.g., be conducted by mapping module 822, if applicable. For example, a mapping from yaw-pitch-roll to quaternions, (or, in other embodiments, vice versa) may, e.g., be conducted by mapping module 822.

Depending on the selected binaural signal pair, gain computation module 830 may, e.g., be configured to calculate panning gains g₁ and g₂ for the selected two binaural signals (the binaural signal pair). E.g., g₂ may, e.g., be set to g₂=g−g₁. A linear interpolation, tangent panning, ambisonics panning or VBAP or EFAP or quaternion based panning may, e.g., be employed to determine g₁ and/or g₂.

For example, if the two binaural signals for a pose offset 0° and θ_{yaw}° have been selected,

$${g}_{2} = \frac{Δ P}{{θ}_{yaw} °} ;$$

g₁=1−g₂.

Or, for example if the two binaural signals for a pose offset 0° and −θ_{yaw}° have been selected, then, for example:

$${g}_{2} = \frac{Δ P}{- {θ}_{yaw} °} ;$$

g₁=1−g₂.

Combination module 840 may, e.g., then be configured to apply the weights on the two binaural signals to obtain two weighted binaural signals and may, e.g., be configured to combine the two weighted binaural signals, e.g., by summing up the two weighted binaural signals. Thus, combination module 840 may, e.g., conduct a combination, e.g., a linear combination of the two binaural signals depending on the two weights.

In other embodiments, more than three binaural signals may, e.g., be received by the selection module 820.

The above explanations for pose correction for the yaw axis are equally applicable for pose correction of the pitch axis and/or the roll axis. In that case, combination module 840 may, for example, be configured to combine the interpolated binaural signal for the yaw axis and the interpolated binaural signal for the pitch axis and/or the interpolated binaural signal for the roll axis, for example, by determining an linear combination of the binaural signals, for example, with an equal weight, e.g., ⅓ (or ½) for each of the three (or two) binaural signals.

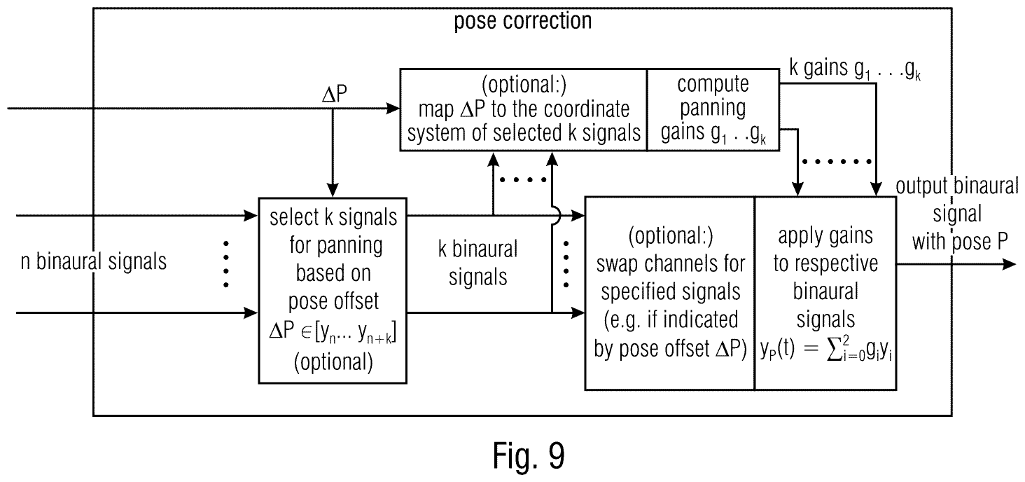

Moreover, the above explanations for pose correction are equally applicable for more than one sound source. In that case, illustrated by FIG. 9, the combination module 840 may, for example, be configured to combine the interpolated binaural signals for the two or more sound sources, e.g., by summing up the binaural signals for the two or more sound sources.

FIG. 9 illustrates an apparatus for complete pose correction implementing a pose correction algorithm for the generic case according to an embodiment.

The complete solution including pose correction over all rotational axes (yaw, pitch and roll), may, e.g., be employed, e.g., together with a more sophisticated version with 3D amplitude panning such as VBAP, EFAP or ambisonics panning or quaternion based panning. Additional signals may, e.g., be employed as a basis for the 3D amplitude panning along with projection of the individual ears onto the vertical and horizontal axes to compensate roll.

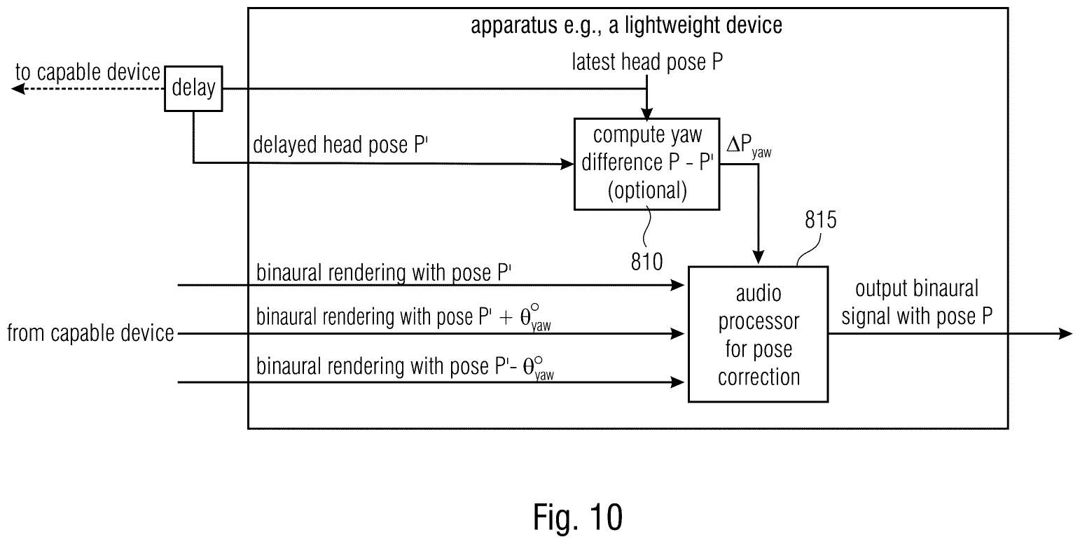

FIG. 10 illustrates an apparatus according to an embodiment for yaw correction.

The apparatus of FIG. 10 may, e.g., be implemented as a lightweight device 210. However, it should be noted that the embodiment of FIG. 10 is not limited to a lightweight device 210 but may, e.g., be implemented as a different kind of other device.

FIG. 10 moreover illustrates an audio processor 815. The audio processor 815 of FIG. 10 is configured to conduct pose correction. The audio processor 815 may, e.g., comprise the selection module 820, the gain computation module 830 and the combination module 840, (and optionally modules 822 and/or 825), and/or may, e.g., implement the functionality of modules 820, 830 and 840 (and, optionally, may implement the functionality of modules 822 and/or 825).

The embodiment of FIG. 10 comprises a pose offset module 810, which may, e.g., be configured to calculate the pose offset ΔP between the latest pose P and the delayed pose P′: ΔP=P−P′.

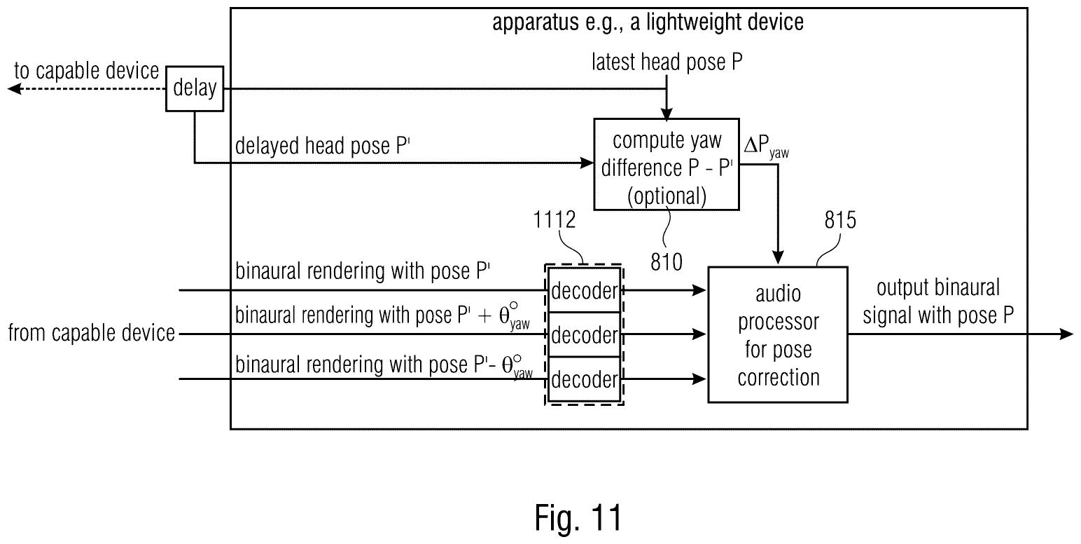

FIG. 11 illustrates an apparatus for a yaw correction according to an embodiment comprising an audio decoder 1112. The audio decoder 1112 of FIG. 11 may, e.g., comprise three decoding units as illustrated in FIG. 11. The apparatus of FIG. 11 may, e.g., be implemented as a lightweight device 210. It should be noted that the embodiment of FIG. 11 is not limited to a lightweight device 210 but may, e.g., be implemented as a different kind of other device.

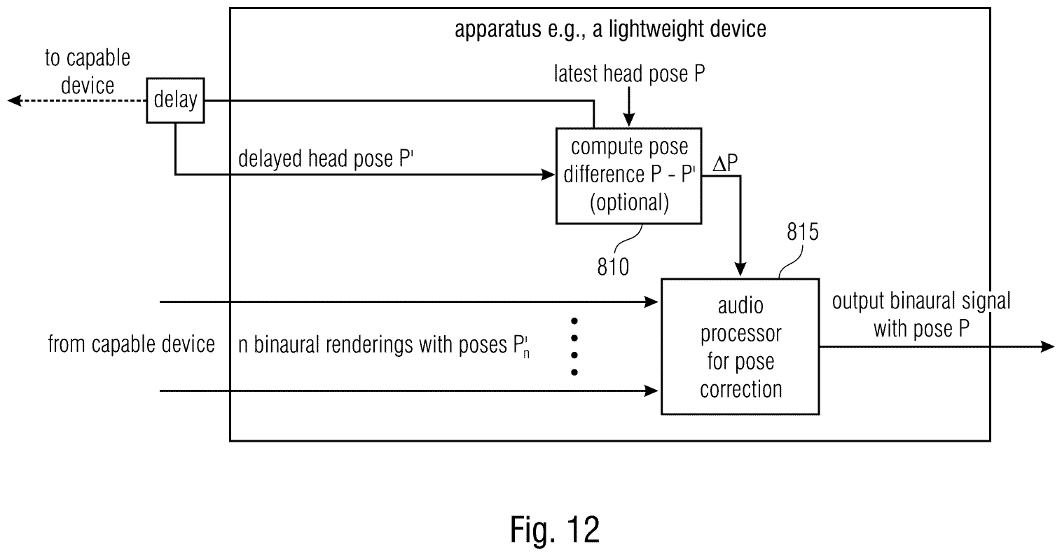

FIG. 12 illustrates an apparatus for complete pose correction according to an embodiment. The apparatus of FIG. 12 may, e.g., be implemented as a lightweight device 210. However, it should be noted that the embodiment of FIG. 12 is not limited to a lightweight device 210 but may, e.g., be implemented as a different kind of other device.

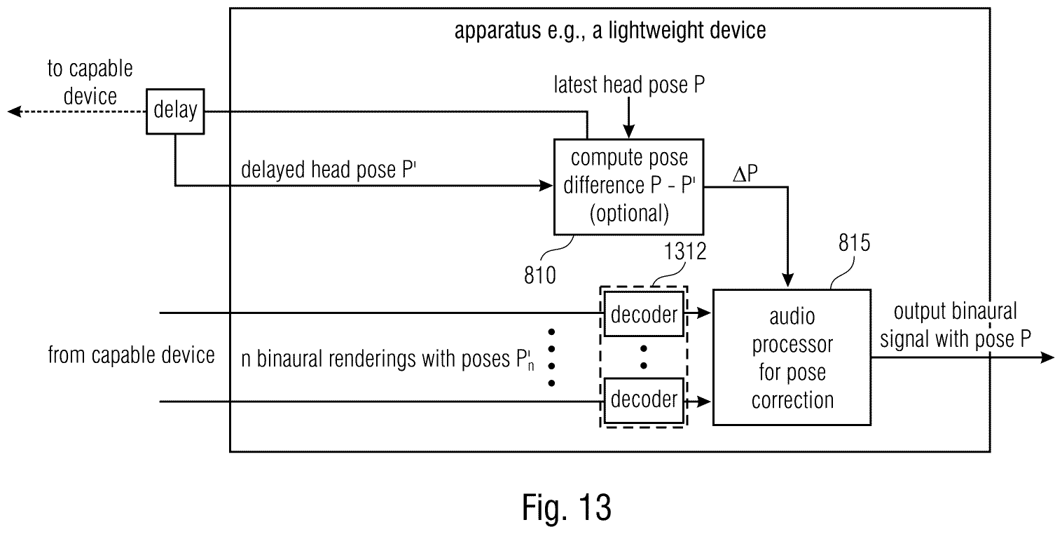

FIG. 13 illustrates an apparatus according to an embodiment for complete pose correction with an audio decoder 1312. The audio decoder 1312 of FIG. 13 may, e.g., comprise a plurality of decoding units. The apparatus of FIG. 13 may, e.g., be implemented as a lightweight device 210. However, it should be noted that the embodiment of FIG. 13 is not limited to a lightweight device 210 but may, e.g., be implemented as a different kind of other device.

Regarding the pose offset module 810 in FIGS. 10, 11, 12 and 13, it should be noted that instead of determining the current pose and the pose offset ΔP by the respective apparatus of FIGS. 10, 11, 12 and 13, in alternative embodiments, the pose offset may, e.g., be received by another apparatus or module. The pose offset module 810 of the respective apparatus of FIGS. 10, 11, 12 and 13 is therefore not a mandatory module, but instead is an optional module of the respective apparatus.

Moreover, in an alternative embodiments of FIGS. 8, 10 and 11, only two binaural signals may, e.g., be received by the apparatus of FIG. 8, such that selection module may, e.g., become obsolete, e.g., in particular, if channel swapping is not employed. In such an embodiment, the two received binaural signals can always be considered to be the two selected binaural signals. Such alternative embodiments are equally applicable for the embodiments of FIGS. 9, 12 and 13.

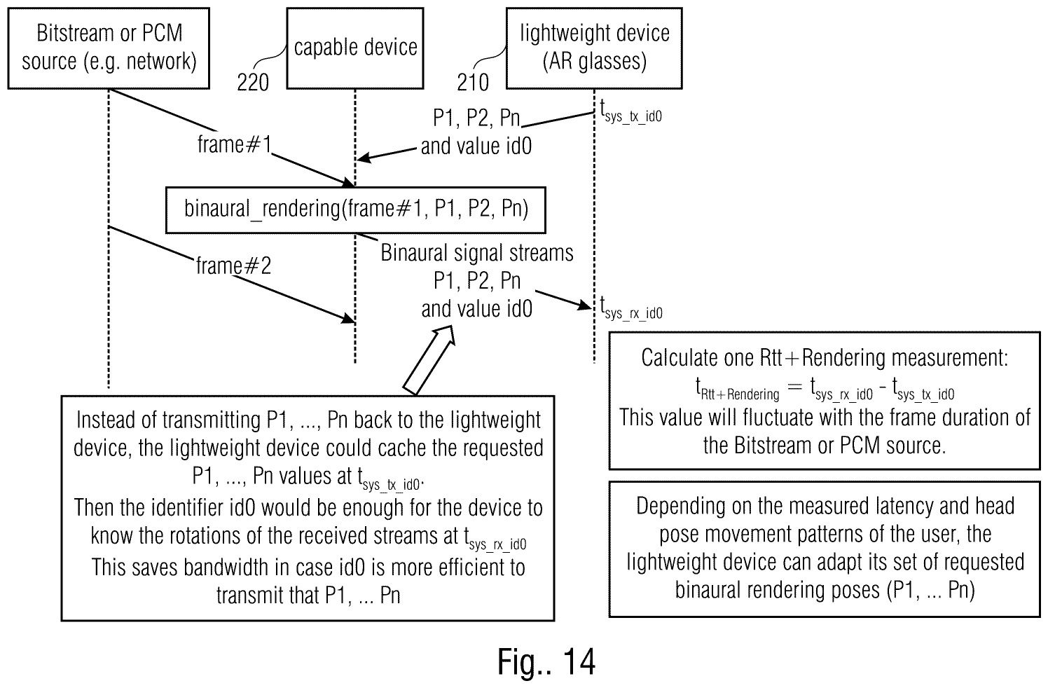

FIG. 14 illustrates a flow chart which depicts a communication flow between a capable device 220 and a lightweight device 210 according to a particular embodiment, wherein the capable device receives a data stream, for example, a bitstream, or a signal, for example, a PCM signal, e.g., from a network entity.

In the following, adaptive pre-rendering according to embodiments is described.

Since the delays between capable device 220 and lightweight device 210 depend heavily on the wireless link, the offsets to be corrected are generally smaller for lower round-trip delays. This allows choosing the value of θ for creating the binaural renderings at P′, (P′+θ_{yaw}°) and (P′−θ_{yaw}°) to adaptive values based on the observed offsets to be corrected.

To allow an adaptive θ, in an embodiment, θ may, for example, be transmitted (e.g., as a rotational offset parameter) from the lightweight device 210 to the capable device 220 (e.g. another apparatus), e.g., via a back channel. In a particular embodiment, each binaural signal may, e.g., comprise the pose P′ used for rendering, e.g., for calculating weights depending on a variable θ. The choice of the aperture angle θ is a trade-off between accuracy of rendering when the pose offset is small versus an ability to interpolate over a wider range of angles for compensating larger offsets.

In other embodiments, instead of transmitting e, multiple poses, for which binaural signals are requested, may, e.g., be transmitted. For example, when a user moves his head to the left, binaural signals could, e.g., be requested for a current head position, and for a current head position extrapolated further left, and for a current head position extrapolated further left and up.

To reduce the bitrate of the provided concepts (e.g., in case of reduced link capacity), the center signal at P′ may, for example, be omitted. This comes with the positive side effect to avoid pre-rendering of one binaural signal, but should only be selected in case the offsets are small.

However, as mentioned earlier, this method is not preferred due to the potential for spatial collapse of the signal.

If the value of θ is set to 0, only the single binaural signal at P′ is sent.

Similarly, if the pre-rendering complexity is of secondary importance, additional signals P′₁, P′₂, . . . , P″ₙ may, e.g., be generated at the capable device 220. This would in general reduce the error of the panning as closer positions based on the offset would be available, and would especially provide a benefit in a one-to-many scenario (where one capable device 220 serves many lightweight devices 210 with the same content, but different head poses per light weight device, leading to large offsets that need to be compensated depending on each light weight device user's pose). Selection of the signals may, e.g., be done by the lightweight device 210 by picking the signals that are most likely close to the user's actual pose or by another intermediate device between the pre-rendering capable device and the lightweight device 210, where the intermediate device may, e.g., conduct selective forwarding of the relevant pose offsets.

Some embodiments exhibit very low complexity, can be applied in time-domain, no transform may, e.g., be required, and such embodiments may, e.g., be codec agnostic.

Effectively, no delay or very low delay may, e.g., occur in such embodiments, and a high time resolution may, e.g., be achieved. For example, weighting may, e.g., be calculated per time domain sample.

Other embodiments may, e.g., alternatively or additionally be applied in a frequency domain.

Some embodiments may, e.g., be able to compensate any offset, wherein a worst case quality may, e.g., be significantly better than according to known technology.

In some embodiments, incorrect spectral cues may, e.g., be mitigated by filtering.

According to some embodiments, adaptive offset selection may, e.g., be employed to reduce a spatial image reduction.

In some embodiments, spatial image reduction may, e.g., be mitigated by transmitting additional signals on the horizontal plane.

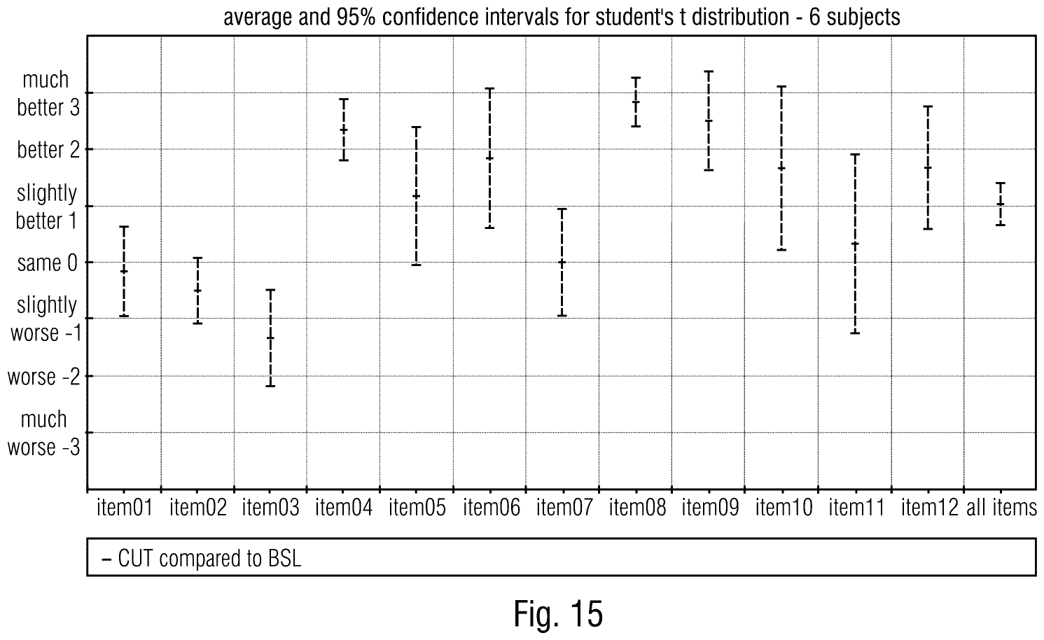

FIG. 15 illustrates first listening test results indicating the averages and the 95% confidence intervals for twelve items.

In further embodiments, one or more of the following implementations is provided:

According to an embodiment, an audio processor is configured to generate a binaural signal, wherein the apparatus is configured to generate the binaural signal by a weighted mixing of two or more binaural signals, wherein the two or more binaural signals comprise a spatial scene at different rotations (e.g., same scene, different head pose applied during rendering).

In an embodiment, weights of the mixing may, e.g., be derived depending current rotational offset from the binaural signals to be mixed.

According to an embodiment, a channel swap of a binaural signal is used as an approximation of a 180° scene rotation.

In an embodiment, the associated relative rotational offset k₁ . . . k_{N} may, e.g., be variably set via a back channel.

According to an embodiment, the associated rotation angle e or multiple requested poses may, e.g., be set depending on the current rotational offset ΔP.

In an embodiment, the associated rotational angle used in pre-rendering may, e.g., be provided as part of the information received, e.g., by a lightweight device.

According to an embodiment, a pre-rendering device may, e.g., create a binaural signal pair for different associated relative rotational offsets k₁ . . . k_{N}.

In an embodiment, the different associated relative rotational offsets k₁ . . . k_{N} may be applied and may, e.g., be embedded as described above.

According to an embodiment, an adaptive selection of channels may, e.g., be dictated by the lightweight device.

In an embodiment, the adaptive selection may, e.g., be based on the current rotational offset ΔP.

According to an embodiment, a mapping of the current rotational offset ΔP to the coordinate system of the transmitted binaural signals may, e.g., be conducted.

In an embodiment, the mapping may, e.g., used with an amplitude or ambisonic panning scheme.

According to an embodiment, a system for audio rendering is provided comprising a capable device and a lightweight device, e.g., wherein delayed head poses may, e.g., be compensated by the transmission of at least two binaural signals corresponding to different associated relative rotational offsets k₁ . . . k_{N}, e.g., wherein the capable device may, e.g., perform the pre-rendering, wherein the lightweight device performs a pose correction, e.g., wherein the transmitted binaural audio signals may, e.g., be compressed using an audio encoder and audio decoder.

According to an embodiment, the processing may, e.g., be performed in a time domain.

In an embodiment, the processing may, e.g., be performed in a filter bank or similar frequency domain.

According to an embodiment, the coded binaural signals may, e.g., be transmitted in the form of a smaller number of transport channels plus metadata. The metadata may, for example, comprise information on the covariance or correlation of the binaural signals corresponding to different scene rotations.

In an embodiment, the binaural signals may, e.g., be generated on the lightweight device using transport audio channels and parametric or model-based HRTFs or acoustic parameters.

According to an embodiment, additional binaural signals may, e.g., be estimated by modifying the binaural cues, such as ILD and ITD, of the original binaural signals.

In the following, further embodiments are described.

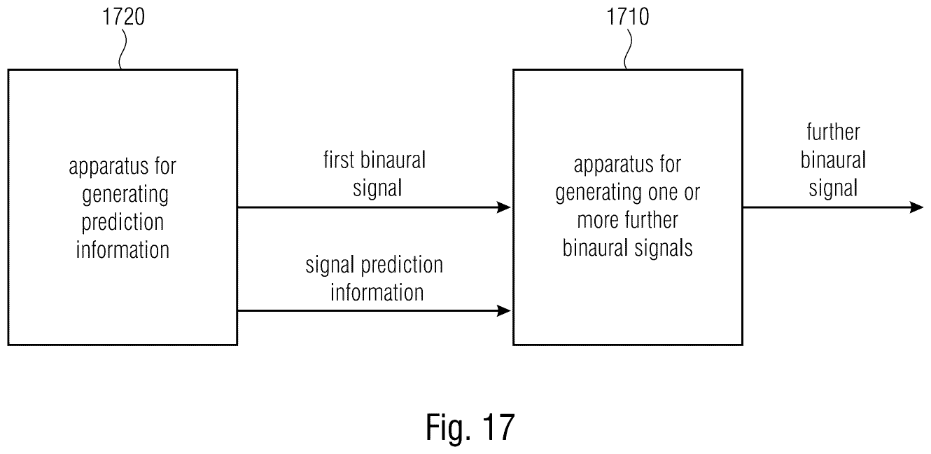

FIG. 17 illustrates a system comprising an apparatus 1720 for generating signal prediction information according to an embodiment, and an apparatus 1710 for generating one or more further binaural signals from a first binaural signal.

According to an embodiment, the apparatus 1720 of FIG. 17 for generating signal prediction information is provided.

The apparatus 1720 is configured to receive pose information, e.g., P′₁ . . . P′_{N}, and/or rotational offset information, e.g., θ.

Moreover, the apparatus 1720 is configured to generate a first binaural signal for a first rotation of an audio scene, and

Furthermore, the apparatus 1720 is configured to generate the signal prediction information depending on the pose information, e.g., P′₁ . . . P′_{N}, and/or the rotational offset information, e.g., θ, such that one or more further binaural signals for one or more further rotations, being different from the first rotation, can be generated using the first binaural signal and using the signal prediction information.

According to an embodiment, the apparatus 1720 may, e.g., be configured to transmit the first binaural signal or an encoding thereof and the signal prediction information or an encoding thereof to another apparatus 1710.

In an embodiment, the apparatus 1720 may, e.g., be configured to receive pose information P′₁ . . . P′_{N} and/or rotational offset information θ from another apparatus 1710.

According to an embodiment, the apparatus 1720 may, e.g., be configured to determine one or more absolute poses P′₁ . . . P′_{N} depending on the pose information and/or depending on the rotational offset information θ; and wherein the apparatus 1720 may, e.g., be configured to generate the signal prediction information by generating pose-specific signal prediction information for each of the one or more absolute poses P′₁ . . . P′_{N}, such that each binaural signal of the one or more further binaural signals may, e.g., be associated with an associated absolute pose P′₁ . . . P′_{N} of the one or more absolute poses P′₁ . . . P′_{N} and can be generated using the first binaural signal and using the pose-specific signal prediction information for said absolute pose. And/or, the apparatus 1720 may, e.g., be configured to determine one or more relative rotational offsets k₁ . . . k_{N} depending on the pose information and/or depending on the rotational offset information θ; and wherein the apparatus 1720 may, e.g., be configured to generate the signal prediction information by generating rotational-offset-specific signal prediction information for each of the one or more relative rotational offsets k₁ . . . k_{N}, such that each binaural signal of the one or more further binaural signals may, e.g., be associated with an associated relative rotational offset k₁ . . . k_{N} of the one or more relative rotational offsets k₁ . . . k_{N} and can be generated using the first binaural signal and using the rotational-offset-specific signal prediction information for said relative rotational offset k₁ . . . k_{N}.

According to an embodiment, the one or more further binaural signals that can be generated from the signal prediction information are two or more further binaural signals.

The apparatus 1720 may, e.g., be configured to determine two or more absolute poses P′₁ . . . P′_{N} depending on the pose information and/or depending on the rotational offset information θ; and wherein the apparatus 1720 may, e.g., be configured to generate the signal prediction information by generating pose-specific signal prediction information for each of the two or more absolute poses P′₁ . . . P′_{N}, such that each binaural signal of the two or more further binaural signals may, e.g., be associated with an associated absolute pose P′₁ . . . P′_{N} of the two or more absolute poses P′₁ . . . P′_{N} and can be generated using the first binaural signal and using the pose-specific signal prediction information for said absolute pose. And/or, the apparatus 1720 may, e.g., be configured to determine two or more relative rotational offsets k₁ . . . k_{N} depending on the pose information and/or depending on the rotational offset information θ; and wherein the apparatus 1720 may, e.g., be configured to generate the signal prediction information by generating rotational-offset-specific signal prediction information for each of the two or more relative rotational offsets k₁ . . . k_{N}, such that each binaural signal of the two or more further binaural signals may, e.g., be associated with an associated relative rotational offset k₁ . . . k_{N} of the two or more relative rotational offsets k₁ . . . k_{N} and can be generated using the first binaural signal and using the rotational-offset-specific signal prediction information for said relative rotational offset k₁ . . . k_{N}.

In an embodiment, the first rotation and the one or more further rotations indicate different head poses of a head within the audio scene, such that the first binaural signal and the one or more further binaural signals are associated with the different head poses of the head.

According to an embodiment, the different head poses of the head are defined with respect to one or more Euler angles. And/or, the different head poses of the head are defined with respect to at least one of a yaw angle and a pitch angle and a roll angle. And/or, the different head poses of the head are defined with respect to a rotation matrix. And/or, the different head poses of the head are defined with respect to one or more quaternions.

In an embodiment, the apparatus 1720 may, e.g., be configured to transmit information on the absolute pose P′₁ . . . P′_{N} of the one or more further binaural signals and/or information on the associated relative rotational offset k₁ . . . k_{N} of the one or more binaural signals, e.g., to another apparatus 1710.

According to an embodiment, the associated absolute pose P′₁ . . . P′_{N}, being associated with each of the two or more binaural signals and/or being associated with the prediction information, indicates the head pose of the head, being defined depending on the one or more Euler angles and/or the yaw angle and/or the pitch angle and/or the roll angle and/or the rotation matrix and/or the one or more quaternions. And/or, the associated relative rotational offset k₁ . . . k_{N}, being associated with each of the two or more binaural signals and/or being associated with the prediction information, indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

In an embodiment, the apparatus 1720 may, e.g., be configured to conduct one or more transmissions to the other apparatus 1710. The transmission comprises the first binaural signal being represented in a time domain, or the transmission comprises the first binaural signal being represented in a frequency domain, or the transmission comprises an encoding of the first binaural signal being represented in the time domain or in the frequency domain.

According to an embodiment, the apparatus 1720 and the further apparatus 1710 are connected via a link with a delay.

In an embodiment, the apparatus 1720 may, e.g., be configured to receive a rotational offset parameter θ as the rotational offset information θ from the other apparatus 1710.

According to an embodiment, the rotational offset parameter θ depends on a current rotational offset ΔP and/or depends on a link latency.

In an embodiment, the apparatus 1720 may, e.g., be configured to receive or to (e.g., dynamically) determine information on a link latency of the transmission. The apparatus 1720 may, e.g., be configured to perform pose prediction depending on the link latency.

According to an embodiment, the apparatus 1720 may, e.g., be configured to receive a current rotational offset ΔP and/or one or more poses P′₁ . . . P′_{N} and/or upstream metadata from the other apparatus 1710. The apparatus 1720 may, e.g., be configured to determine the rotational offset parameter θ using the current rotational offset ΔP and/or using the one or more poses P′₁ . . . P′_{N} and/or using the upstream metadata.

In an embodiment, the apparatus 1720 may, e.g., be configured to transmit a rotational offset parameter θ as the rotational offset information θ to the other apparatus 1710.

In another embodiment, the apparatus 1710 of FIG. 17 for generating one or more further binaural signals from a first binaural signal using signal prediction information is provided.

The apparatus 1710 is configured to receive the first binaural signal for a first rotation of an audio scene.

Moreover, the apparatus 1710 is configured to receive signal prediction information which depends on pose information, e.g., P′₁ . . . P′_{N}, and/or which depends on rotational offset information, e.g., θ.

Furthermore, the apparatus 1710 is configured to generate the one or more further binaural signals for one or more further rotations, being different from the first rotation using the first binaural signal and using the signal prediction information.

According to an embodiment, the apparatus 1710 may, e.g., be configured to receive the first binaural signal or an encoding thereof and the signal prediction information or an encoding thereof from another apparatus 1720.

In an embodiment, the apparatus 1710 may, e.g., be configured to transmit the pose information and/or the rotational offset information θ to the other apparatus 1720.

According to an embodiment, one or more absolute poses P′₁ . . . P′_{N} depend on the pose information and/or depend on the rotational offset information θ; and the signal prediction information depends on pose-specific signal prediction information for each of the one or more absolute poses P′₁ . . . P′_{N}, such that each binaural signal of the one or more further binaural signals may, e.g., be associated with an associated absolute pose P′₁ . . . P′_{N} of the one or more absolute poses P′₁ . . . P′_{N}, wherein the apparatus 1710 may, e.g., be configured to generate said binaural signal using the first binaural signal and using the pose-specific signal prediction information for said absolute pose. And/or, one or more relative rotational offsets k₁ . . . k_{N} depend on the pose information and/or depend on the rotational offset information θ; and the signal prediction information depends on rotational-offset-specific signal prediction information for each of the one or more relative rotational offsets k₁ . . . k_{N}, such that each binaural signal of the one or more further binaural signals may, e.g., be associated with an associated relative rotational offset k₁ . . . k_{N} of the one or more relative rotational offsets k₁ . . . k_{N}, wherein the apparatus 1710 may, e.g., be configured to generate said binaural signal using the first binaural signal and using the rotational-offset-specific signal prediction information for said relative rotational offset k₁ . . . k_{N}.

In an embodiment, the apparatus 1710 may, e.g., be configured to generate two or more further binaural signals as the one or more further binaural signals. Two or more absolute poses P′₁ . . . P′_{N} depend on the pose information and/or depend on the rotational offset information θ; and the signal prediction information depends on pose-specific signal prediction information for each of the two or more absolute poses P′₁ . . . P′_{N}, such that each binaural signal of the two or more further binaural signals may, e.g., be associated with an associated absolute pose P′₁ . . . P′_{N} of the two or more absolute poses P′₁ . . . P′_{N}, wherein the apparatus 1710 may, e.g., be configured to generate said binaural signal using the first binaural signal and using the pose-specific signal prediction information for said absolute pose. And/or, two or more relative rotational offsets k₁ . . . k_{N} depend on the pose information and/or depend on the rotational offset information θ; and the signal prediction information depends on rotational-offset-specific signal prediction information for each of the two or more relative rotational offsets k₁ . . . k_{N}, such that each binaural signal of the two or more further binaural signals may, e.g., be associated with an associated relative rotational offset k₁ . . . k_{N} of the two or more relative rotational offsets k₁ . . . k_{N}, wherein the apparatus 1710 may, e.g., be configured to generate said binaural signal using the first binaural signal and using the rotational-offset-specific signal prediction information for said relative rotational offset k₁ . . . k_{N}.

In another embodiment, the apparatus 1710 may, e.g., be configured to generate two or more further binaural signals as the one or more further binaural signals.

Two or more absolute poses P′₁ . . . P′_{N} depend on the pose information and/or depend on the rotational offset information θ; and the signal prediction information depends on pose-specific signal prediction information for each of the two or more absolute poses P′₁ . . . P′_{N}, such that each binaural signal of the two or more further binaural signals is associated with an associated absolute pose P′₁ . . . P′_{N} of the two or more absolute poses P′₁ . . . P′_{N}. The apparatus 1710 may, e.g., configured to generate a binaural signal for another absolute pose, for example, for the current pose P, by interpolating or extrapolating the pose-specific signal prediction information for at least two of the two or more absolute poses P′₁ . . . P′_{N} depending on said other absolute pose to obtain interpolated or extrapolated pose-specific signal prediction information, and by generating the binaural signal for said other absolute pose using the first binaural signal and using the interpolated or extrapolated pose-specific signal prediction information.

And/or, two or more relative rotational offsets k₁ . . . k_{N} depend on the pose information and/or depend on the rotational offset information θ; and the signal prediction information depends on rotational-offset-specific signal prediction information for each of the two or more relative rotational offsets k₁ . . . k_{N}, such that each binaural signal of the two or more further binaural signals is associated with an associated relative rotational offset k₁ . . . k_{N}, of the two or more relative rotational offsets k₁ . . . k_{N}, wherein the apparatus 1710 may, e.g., be configured to generate a binaural signal for another relative rotational offset by interpolating or extrapolating the rotational-offset-specific signal prediction information for at least two of the two or more relative rotational offsets k₁ . . . k_{N} depending on said other relative rotational offset to obtain interpolated or extrapolated rotational-offset-specific signal prediction information, and by generating the binaural signal for said other relative rotational offset, for example, for a current relative rotational offset, using the first binaural signal and using the interpolated or extrapolated rotational-offset-specific signal prediction information.

According to an embodiment, the pose-specific signal prediction information for each absolute pose of the one or more absolute poses P′₁ . . . P′_{N} may, e.g., be a pose-specific prediction matrix for said absolute pose, wherein the apparatus 1710 may, e.g., be configured to generate the binaural signal being associated with said absolute pose P′₁ . . . P′_{N} by applying the pose-specific prediction matrix on the first binaural signal.

And/or, the interpolated or extrapolated pose-specific signal prediction information for said other absolute pose may, e.g., be a pose-specific prediction matrix for said other absolute pose, wherein the apparatus 1710 may, e.g., be configured to generate the binaural signal being associated with said other absolute pose by applying the pose-specific prediction matrix on the first binaural signal.

And/or, the offset-specific signal prediction information for each relative rotational offset k₁ . . . k_{N} of the one or more relative rotational offsets k₁ . . . k_{N} may, e.g., be an offset-specific prediction matrix for said relative rotational offset k₁ . . . k_{N}, wherein the apparatus 1710 may, e.g., be configured to generate the binaural signal being associated with said relative rotational offset k₁ . . . k_{N} by applying the offset-specific prediction matrix on the first binaural signal.

And/or, the interpolated or extrapolated rotational-offset-specific signal prediction information for said other relative rotational offset may, e.g., be an offset-specific prediction matrix for said other relative rotational offset, wherein the apparatus 1710 may, e.g., be configured to generate the binaural signal being associated with said other relative rotational offset by applying the offset-specific prediction matrix on the first binaural signal.

In an embodiment, the pose-specific prediction matrix for said absolute pose P′₁ . . . P′_{N} may, e.g., be a 2×2 matrix, wherein the apparatus 1710 may, e.g., be configured to apply the pose-specific prediction matrix on a first channel and on a second channel of the first binaural signal to generate a first channel and a second channel of the binaural signal being associated with said absolute pose P′₁ . . . P′_{N}. And/or, the offset-specific prediction matrix for said relative rotational offset k₁ . . . k_{N} may, e.g., be a 2×2 matrix, wherein the apparatus 1710 may, e.g., be configured to apply the offset-specific prediction matrix on a first channel and on a second channel of the first binaural signal to generate a first channel and a second channel of the binaural signal being associated with said relative rotational offset k₁ . . . k_{N} .

According to an embodiment, the first rotation and the one or more further rotations indicate different head poses of a head within the audio scene, such that the first binaural signal and the one or more further binaural signals are associated with the different head poses of the head.

In an embodiment, the different head poses of the head are defined with respect to one or more Euler angles. And/or, the different head poses of the head are defined with respect to at least one of a yaw angle and a pitch angle and a roll angle. And/or the different head poses of the head are defined with respect to a rotation matrix. And/or, the different head poses of the head are defined with respect to one or more quaternions.

According to an embodiment, the apparatus 1710 may, e.g., be configured to receive information on the absolute pose P′₁ . . . P′_{N} of the one or more further binaural signals and/or information on the associated relative rotational offset k₁ . . . k_{N} of the one or more binaural signals, e.g., from another apparatus 1720.

In an embodiment, the associated absolute pose P′₁ . . . P′_{N}, being associated with each of the two or more binaural signals and/or being associated with the prediction information, indicates the head pose of the head, being defined depending on the one or more Euler angles and/or the yaw angle and/or the pitch angle and/or the roll angle and/or the rotation matrix and/or the one or more quaternions. And/or, the associated relative rotational offset k₁ . . . k_{N} , being associated with each of the two or more binaural signals and/or being associated with the prediction information, indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

According to an embodiment, the apparatus 1710 may, e.g., be configured to receive one or more transmissions from the other apparatus 1720. The transmission comprises the first binaural signal being represented in a time domain, or the transmission comprises the first binaural signal being represented in a frequency domain, or the transmission comprises an encoding of the first binaural signal being represented in the time domain or in the frequency domain.

In an embodiment, the apparatus 1710 and the further apparatus 1720 are connected via a link with a delay.

According to an embodiment, the apparatus 1710 may, e.g., be configured to transmit a rotational offset parameter θ as the rotational offset information θ to the other apparatus 1720.

In an embodiment, the rotational offset parameter θ depends on a current rotational offset ΔP depends on a current rotational offset ΔP and/or depends on a link latency.

In general, as already outlined above, according to a particular embodiment, if the link latency is greater, usually, θ will be set greater, as due to the greater/larger latency, it can be expected that during transmission latency, a larger movement/rotational offset, e.g., of a head, will occur, compared to a situation, where the latency is smaller.

According to an embodiment, the apparatus 1710 may, e.g., be configured to transmit or to (e.g., dynamically) determine information on a link latency of the transmission.

In an embodiment, the apparatus 1710 may, e.g., be configured to receive or to (e.g., dynamically) determine information on a link latency of the transmission. The apparatus 1710 may, e.g., be configured to perform pose prediction depending on the link latency.

In an embodiment, the apparatus 1710 may, e.g., be configured to transmit a current rotational offset ΔP and/or one or more poses P₁ . . . P_{N} and/or upstream metadata for determining the rotational offset parameter θ to the other apparatus 1720.

According to an embodiment, the apparatus 1710 may, e.g., be configured to receive a rotational offset parameter θ as the rotational offset information θ from the other apparatus 1720.

In a further embodiment, a system comprising the apparatus 1710 and the apparatus 1720 is provided.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for processing two or more first binaural signals, wherein the apparatus comprises:
an audio processor configured for conducting a weighted mixing of the two or more first binaural signals to obtain a combined binaural signal,
wherein the two or more first binaural signals are two or more binaural audio signals for different rotations of a same audio scene.

2. An apparatus according to claim 1,
wherein the different rotations indicate different head poses of a head within the audio scene, such that the two or more first binaural signals are associated with the different head poses of the head.

3. An apparatus according to claim 2,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions.

4. An apparatus according to claim 1,
wherein each of the two or more first binaural signals is associated with an associated absolute pose being different from the associated absolute pose of any other one of the two or more first binaural signals, and/or
wherein each of the two or more first binaural signals is associated with an associated relative rotational offset being different from the associated relative rotational offset of any other one of the two or more first binaural signals.

5. An apparatus according to claim 4,
wherein the apparatus is configured to receive information on the associated absolute pose of the two or more first binaural signals and/or information on the associated relative rotational offset of the two or more first binaural signals, e.g., from another apparatus.

6. An apparatus according to claim 3,
wherein each of the two or more first binaural signals is associated with an associated absolute pose being different from the associated absolute pose of any other one of the two or more first binaural signals, and/or
wherein each of the two or more first binaural signals is associated with an associated relative rotational offset being different from the associated relative rotational offset of any other one of the two or more first binaural signals,
wherein the associated absolute pose being associated with each of the two or more first binaural signals indicates the head pose of the head, being defined depending on the one or more Euler angles and/or the yaw angle and/or the pitch angle and/or the roll angle and/or the rotation matrix and/or the one or more quaternions; and/or
wherein the associated relative rotational offset being associated with each of the two or more first binaural signals indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

7. An apparatus according to claim 4,
wherein the audio processor is configured to conduct the weighted mixing depending on one or more weights,
wherein the audio processor is configured to determine the one or more weights depending on the associated absolute pose or the associated relative rotational offset being associated with each of the two or more first binaural signals, and depending on a current rotational offset between a current pose and a previous pose,
wherein the current rotational offset indicates the at least one difference between the current rotation angle and the previous rotation angle with respect to a rotation axis.

8. An apparatus according to claim 7,
wherein the audio processor is configured to determine the one or more weights by determining a weight for each binaural signal of the two or more first binaural signals, such that the weight for the binaural signal depends on a difference between the current rotational offset and the associated relative rotational offset being associated with the binaural signal.

9. An apparatus according to claim 7,
wherein the audio processor is configured to receive three or more binaural input signals, each of which being associated with an associated absolute pose or an associated relative rotational offset, and
wherein, to obtain the two or more first binaural audio signals, the audio processor is configured to select at least two selected binaural signals of the three or more binaural input signals depending on the current rotational offset and depending on the associated absolute pose or the associated relative rotational offset of each of the three or more binaural input signals.

10. An apparatus according to claim 9,
wherein the audio signal processor is configured to determine whether to swap the two audio channels of a binaural signal of the at least two selected binaural signals with each other, depending on the current rotational offset and depending on the associated absolute pose the associated relative rotational offset being associated with the binaural signal, and
wherein the audio signal processor is configured, if it has been determined that the two audio channels shall be swapped, the audio signal processor is configured to swap the two audio channels of the binaural signal with each other to obtain one of the two or more first binaural signals.

11. An apparatus according to claim 7,
wherein a first signal processor and a second signal processor together form the audio signal processor,
wherein the first signal processor is configured to receive a first channel of three or more binaural input signals, each of which being associated with an associated absolute pose or an associated relative rotational offset, and
wherein, to obtain a first channel of each of the two or more first binaural audio signals, the first signal processor is configured to select at least two selected binaural signals of the three or more binaural input signals depending on the current rotational offset and depending on the associated absolute pose or the associated relative rotational offset of each of the three or more binaural input signals; wherein the first signal processor is configured to conduct a weighted mixing of the first channel of each two or more first binaural signals to obtain a first channel of the combined binaural signal;
wherein, to obtain a second channel of each of the two or more first binaural audio signals, the second signal processor is configured to select at least two selected binaural signals of the three or more binaural input signals depending on the current rotational offset and depending on the associated absolute pose or the associated relative rotational offset of each of the three or more binaural input signals; wherein the second signal processor is configured to conduct a weighted mixing of the second channel of each two or more first binaural signals to obtain a second channel of the combined binaural signal.

12. An apparatus according to claim 11,
wherein the first signal processor and the second signal processor are spaced from each other.

13. An apparatus according to claim 12,
wherein the apparatus comprises a pair of two earbuds,
wherein the first signal processor is implemented in a first one of the two earbuds, and
wherein the second signal processor is implemented in a second one of the two earbuds.

14. An apparatus according to claim 1,
wherein the apparatus is configured to obtain two or more binaural input signals from one or more transmissions of another apparatus.

15. An apparatus according to claim 14,
wherein the transmission comprises the two or more binaural input signals being represented in a time domain, or
wherein the transmission comprises the two or more binaural input signals being represented in a frequency domain, or
wherein the transmission comprises an encoding of the two or more binaural input signals being represented in the time domain or in the frequency domain.

16. An apparatus according to claim 14,
wherein the apparatus and the further apparatus are connected via a link with a delay.

17. An apparatus according to claim 7,
wherein the apparatus is configured to obtain two or more binaural input signals from one or more transmissions of another apparatus,
wherein at least one of the two or more binaural input signals depends on a rotational offset parameter and is associated with an associated absolute pose or with an associated relative rotational offset, which depends on the rotational offset parameter,
wherein each of the two or more first binaural signals corresponds to one of the two or more binaural input signals or is derived from one of the two or more binaural input signals.

18. An apparatus according to claim 17,
wherein the apparatus is configured to transmit the rotational offset parameter to another apparatus, and
wherein the apparatus is configured to receive the transmission from the other apparatus comprising the two or more binaural input signals or an encoding thereof.

19. An apparatus according to claim 18,
wherein the apparatus is configured to determine the rotational offset parameter depending on the current rotational offset; and/or
wherein the apparatus is configured to determine the rotational offset parameter depending on a link latency.

20. An apparatus according to claim 14,
wherein the apparatus is configured to receive or to determine information on a link latency of the transmission,
wherein the apparatus is configured to perform pose prediction depending on the link latency.

21. An apparatus according to claim 17,
wherein the apparatus is configured to transmit the current rotational offset and/or one or more poses and/or upstream metadata to another apparatus.

22. An apparatus according to claim 17,
wherein the apparatus is configured to receive the transmission from the other apparatus comprising the two or more binaural input signals or an encoding thereof,
wherein the apparatus is configured to receive the rotational offset parameter from the other apparatus, and
wherein the apparatus is configured to determine the two or more first binaural signals from the two or more binaural input signals depending on the current rotational offset; or is configured to determine the one or more weights depending on the current rotational offset.

23. An apparatus according to claim 22,
wherein the apparatus is configured to determine the two or more first binaural signals from the two or more binaural input signals or is configured to determine the one or more weights by employing a linear panning or by employing a tangent panning or by employing Vector Base Amplitude Panning or by employing Edge Fading Amplitude Panning or by employing ambisonic panning or quaternion based panning.

24. An apparatus according to claim 14,
wherein the apparatus is configured to receive the transmission from the other apparatus comprising a number of one or more transmitted binaural signals or an encoding thereof and metadata, the number being smaller than the number of the two or more binaural input signals, and
wherein the apparatus is configured to obtain the two or more binaural input signals from the transmission by reconstructing the two or more binaural input signals from the one or more transmitted binaural signals using the metadata.

25. An apparatus according to claim 14,
wherein the transmission comprises one or more parametric or model-based head-related transfer functions and/or acoustic parameters, or an encoding thereof, and
wherein the apparatus is configured to obtain the two or more binaural input signals using the one or more parametric model-based head-related transfer functions and/or the acoustic parameters.

26. An apparatus according to claim 1,
wherein the audio processor is configured to obtain one or more additional binaural signals from the two or more binaural input signals by modifying binaural cues of at least one of the two or more binaural input signals, and
wherein the audio processor is configured to obtain the two or more first binaural signals from the two or more binaural input signals and from the one or more additional binaural signals.

27. An apparatus according to claim 7,
wherein the apparatus comprises a pose offset module for determining the current rotational offset between the current pose and the previous pose, wherein the current rotational offset indicates the at least one difference between the current rotation angle and the previous rotation angle with respect to a rotation axis.

28. An apparatus according to claim 1,
wherein the audio processor is configured to conduct the weighted mixing of the two or more first binaural signals in a time domain, or
wherein the audio processor is configured to conduct the weighted mixing of the two or more first binaural signals in the frequency domain.

29. An apparatus for generating two or more binaural signals,
wherein the apparatus is configured for generating the two or more binaural signals being two or more binaural audio signals for different rotations of a same audio scene.

30. An apparatus according to claim 29,
wherein the different rotations indicate different head poses of a head within the audio scene, such that the two or more binaural signals are associated with the different head poses of the head.

31. An apparatus according to claim 30,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions.

32. An apparatus according to claim 29,
wherein each of the two or more binaural signals is associated with an associated absolute pose being different from the associated absolute pose of any other one of the two or more binaural signals, and/or
wherein each of the two or more binaural signals is associated with an associated relative rotational offset being different from the associated relative rotational offset of any other one of the two or more binaural signals.

33. An apparatus according to claim 32,
wherein the apparatus is configured to transmit information on the associated absolute pose of the two or more binaural signals and/or information on the associated relative rotational offset of the two or more binaural signals, e.g., to another apparatus.

34. An apparatus according to claim 31,
wherein each of the two or more binaural signals is associated with an associated absolute pose being different from the associated absolute pose of any other one of the two or more binaural signals, and/or
wherein each of the two or more binaural signals is associated with an associated relative rotational offset being different from the associated relative rotational offset of any other one of the two or more binaural signals,
wherein the associated absolute pose being associated with each of the two or more binaural signals indicates the head pose of the head, being defined depending on the one or more Euler angles and/or the yaw angle and/or the pitch angle and/or the roll angle and/or the rotation matrix and/or the one or more quaternions; and/or
wherein the associated relative rotational offset being associated with each of the two or more binaural signals indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

35. An apparatus according to claim 29,
wherein the apparatus is configured to conduct one or more transmissions to transmit the two or more binaural signals to a further apparatus.

36. An apparatus according to claim 35,
wherein the transmission comprises the two or more binaural input signals being represented in a time domain, or
wherein the transmission comprises the two or more binaural input signals being represented in a frequency domain, or
wherein the transmission comprises an encoding of the two or more binaural input signals being represented in the time domain or in the frequency domain.

37. An apparatus according to claim 35,
wherein the apparatus and the further apparatus are connected via a link with a delay.

38. An apparatus according to claim 29,
wherein each of the two or more binaural signals is associated with an associated absolute pose being different from the associated absolute pose of any other one of the two or more binaural signals, and/or
wherein each of the two or more binaural signals is associated with an associated relative rotational offset being different from the associated relative rotational offset of any other one of the two or more binaural signals,
wherein at least one of the two or more binaural signals depends on a rotational offset parameter and is associated with an associated absolute pose or with an associated relative rotational offset, which depends on the rotational offset parameter.

39. An apparatus according to claim 38,
wherein the apparatus is configured to receive the rotational offset parameter from another apparatus, and
wherein the apparatus is configured to transmit the two or more binaural signals or an encoding thereof to the other apparatus.

40. An apparatus according to claim 39,
wherein the rotational offset parameter depends on a current rotational offset.

41. An apparatus according to claim 35,
wherein the apparatus is configured to receive or to determine information on a link latency of the transmission,
wherein the apparatus is configured to perform pose prediction depending on the link latency.

42. An apparatus according to claim 38,
wherein the apparatus is configured to receive a current rotational offset and/or one or more poses and/or upstream metadata from another apparatus, and
wherein the apparatus is configured to determine the rotational offset parameter using the current rotational offset and/or using the one or more poses and/or using the upstream metadata.

43. An apparatus according to claim 38,
wherein the apparatus is configured to transmit the two or more binaural signals or an encoding thereof to the other apparatus, and
wherein the apparatus is configured to transmit the rotational offset parameter to the other apparatus.

44. An apparatus according to claim 29,
wherein the apparatus is configured to conduct one or more transmissions to transmit the two or more binaural signals to a further apparatus,
wherein the apparatus is configured to transmit a number of one or more binaural transmission signals or an encoding thereof and metadata, the number being smaller than the number of the two or more binaural signals.

45. An apparatus according to claim 29,
wherein the apparatus is configured to conduct one or more transmissions to transmit the two or more binaural signals to a further apparatus,
wherein the apparatus is configured to transmit one or more parametric or model-based head-related transfer functions and/or acoustic parameters, or an encoding thereof.

46. A system comprising,
one or more the apparatuses according to claim 1, and
an apparatus for generating two or more binaural signals, wherein the apparatus is configured for generating the two or more binaural signals being two or more binaural audio signals for different rotations of a same audio scene.

47. A method for processing two or more first binaural signals, wherein the method comprises:
conducting a weighted mixing of the two or more first binaural signals to obtain a combined binaural signal,
wherein the two or more first binaural signals are two or more binaural audio signals for different rotations of a same audio scene.

48. A method for generating two or more binaural signals,
wherein the method comprises generating the two or more binaural signals being two or more binaural audio signals for different rotations of a same audio scene.

49. A non-transitory computer-readable medium comprising a computer program for implementing the method of claim 47 when being executed on a computer or signal processor.

50. An apparatus for generating signal prediction information,
wherein the apparatus is configured to receive pose information and/or rotational offset information,
wherein the apparatus is configured to generate a first binaural signal for a first rotation of an audio scene, and
wherein the apparatus is configured to generate the signal prediction information depending on the pose information and/or the rotational offset information, such that one or more further binaural signals for one or more further rotations, being different from the first rotation, can be generated using the first binaural signal and using the signal prediction information.

51. An apparatus according to claim 50,
wherein the apparatus is configured to transmit the first binaural signal or an encoding thereof and the signal prediction information or an encoding thereof to another apparatus.

52. An apparatus according to claim 51,
wherein the apparatus is configured to receive pose information and/or rotational offset information from another apparatus.

53. An apparatus according to claim 50,
wherein the apparatus is configured to determine one or more absolute poses depending on the pose information and/or depending on the rotational offset information; and wherein the apparatus is configured to generate the signal prediction information by generating pose-specific signal prediction information for each of the one or more absolute poses, such that each binaural signal of the one or more further binaural signals is associated with an associated absolute pose of the one or more absolute poses and can be generated using the first binaural signal and using the pose-specific signal prediction information for said absolute pose; and/or
wherein the apparatus is configured to determine one or more relative rotational offsets depending on the pose information and/or depending on the rotational offset information; and wherein the apparatus is configured to generate the signal prediction information by generating rotational-offset-specific signal prediction information for each of the one or more relative rotational offsets, such that each binaural signal of the one or more further binaural signals is associated with an associated relative rotational offset of the one or more relative rotational offsets and can be generated using the first binaural signal and using the rotational-offset-specific signal prediction information for said relative rotational offset.

54. An apparatus according to claim 50,
wherein the one or more further binaural signals that can be generated from the signal prediction information are two or more further binaural signals;
wherein the apparatus is configured to determine two or more absolute poses depending on the pose information and/or depending on the rotational offset information; and wherein the apparatus is configured to generate the signal prediction information by generating pose-specific signal prediction information for each of the two or more absolute poses, such that each binaural signal of the two or more further binaural signals is associated with an associated absolute pose of the two or more absolute poses and can be generated using the first binaural signal and using the pose-specific signal prediction information for said absolute pose; and/or
wherein the apparatus is configured to determine two or more relative rotational offsets depending on the pose information and/or depending on the rotational offset information; and wherein the apparatus is configured to generate the signal prediction information by generating rotational-offset-specific signal prediction information for each of the two or more relative rotational offsets, such that each binaural signal of the two or more further binaural signals is associated with an associated relative rotational offset of the two or more relative rotational offsets and can be generated using the first binaural signal and using the rotational-offset-specific signal prediction information for said relative rotational offset.

55. An apparatus according to claim 50,
wherein the first rotation and the one or more further rotations indicate different head poses of a head within the audio scene, such that the first binaural signal and the one or more further binaural signals are associated with the different head poses of the head.

56. An apparatus according to claim 55,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions.

57. An apparatus according to claim 53,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions,
wherein the apparatus is configured to transmit information on the absolute pose of the one or more further binaural signals and/or information on the associated relative rotational offset of the one or more binaural signals, e.g., to another apparatus.

58. An apparatus according to claim 53,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions
wherein the associated absolute pose, being associated with each of the two or more binaural signals and/or being associated with the prediction information, indicates the head pose of the head, being defined depending on the one or more Euler angles and/or the yaw angle and/or the pitch angle and/or the roll angle and/or the rotation matrix and/or the one or more quaternions; and/or
wherein the associated relative rotational offset, being associated with each of the two or more binaural signals and/or being associated with the prediction information, indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

59. An apparatus according to claim 50,
wherein the apparatus is configured to transmit the first binaural signal or an encoding thereof and the signal prediction information or an encoding thereof to another apparatus,
wherein the apparatus is configured to conduct one or more transmissions to the other apparatus,
wherein the transmission comprises the first binaural signal being represented in a time domain, or
wherein the transmission comprises the first binaural signal being represented in a frequency domain, or
wherein the transmission comprises an encoding of the first binaural signal being represented in the time domain or in the frequency domain.

60. An apparatus according to claim 50,
wherein the apparatus is configured to transmit the first binaural signal or an encoding thereof and the signal prediction information or an encoding thereof to another apparatus,
wherein the apparatus and the further apparatus are connected via a link with a delay.

61. An apparatus according to claim 50,
wherein the apparatus is configured to transmit the first binaural signal or an encoding thereof and the signal prediction information or an encoding thereof to another apparatus,
wherein the apparatus is configured to receive a rotational offset parameter as the rotational offset information from the other apparatus.

62. An apparatus according to claim 61,
wherein the rotational offset parameter depends on a current rotational offset and/or depends on a link latency.

63. An apparatus according to claim 50,
wherein the apparatus is configured to transmit the first binaural signal or an encoding thereof and the signal prediction information or an encoding thereof to another apparatus,
wherein the apparatus is configured to receive or to determine information on a link latency of the transmission,
wherein the apparatus is configured to perform pose prediction depending on the link latency.

64. An apparatus according to claim 50,
wherein the apparatus is configured to transmit the first binaural signal or an encoding thereof and the signal prediction information or an encoding thereof to another apparatus,
wherein the apparatus is configured to receive a current rotational offset and/or one or more poses and/or upstream metadata from the other apparatus, and
wherein the apparatus is configured to determine the rotational offset parameter using the current rotational offset and/or using the one or more poses and/or using the upstream metadata.

65. An apparatus according to claim 50,
wherein the apparatus is configured to transmit the first binaural signal or an encoding thereof and the signal prediction information or an encoding thereof to another apparatus,
wherein the apparatus is configured to transmit a rotational offset parameter as the rotational offset information to the other apparatus.

66. An apparatus for generating one or more further binaural signals from a first binaural signal using signal prediction information,
wherein the apparatus is configured to receive the first binaural signal for a first rotation of an audio scene,
wherein the apparatus is configured to receive signal prediction information which depends on pose information and/or which depends on rotational offset information, and
wherein the apparatus is configured to generate the one or more further binaural signals for one or more further rotations, being different from the first rotation using the first binaural signal and using the signal prediction information.

67. An apparatus according to claim 66,
wherein the apparatus is configured to receive the first binaural signal or an encoding thereof and the signal prediction information or an encoding thereof from another apparatus.

68. An apparatus according to claim 67,
wherein the apparatus is configured to transmit the pose information and/or the rotational offset information to the other apparatus.

69. An apparatus according to claim 66,
wherein one or more absolute poses depend on the pose information and/or depend on the rotational offset information; and the signal prediction information depends on pose-specific signal prediction information for each of the one or more absolute poses, such that each binaural signal of the one or more further binaural signals is associated with an associated absolute pose of the one or more absolute poses, wherein the apparatus is configured to generate said binaural signal using the first binaural signal and using the pose-specific signal prediction information for said absolute pose; and/or
wherein one or more relative rotational offsets depend on the pose information and/or depend on the rotational offset information; and the signal prediction information depends on rotational-offset-specific signal prediction information for each of the one or more relative rotational offsets, such that each binaural signal of the one or more further binaural signals is associated with an associated relative rotational offset of the one or more relative rotational offsets, wherein the apparatus is configured to generate said binaural signal using the first binaural signal and using the rotational-offset-specific signal prediction information for said relative rotational offset.

70. An apparatus according to claim 66,
wherein the apparatus is configured to generate two or more further binaural signals as the one or more further binaural signals;
wherein two or more absolute poses depend on the pose information and/or depend on the rotational offset information; and the signal prediction information depends on pose-specific signal prediction information for each of the two or more absolute poses, such that each binaural signal of the two or more further binaural signals is associated with an associated absolute pose of the one or more absolute poses, wherein the apparatus is configured to generate said binaural signal using the first binaural signal and using the pose-specific signal prediction information for said absolute pose; and/or
wherein two or more relative rotational offsets depend on the pose information and/or depend on the rotational offset information; and the signal prediction information depends on rotational-offset-specific signal prediction information for each of the two or more relative rotational offsets, such that each binaural signal of the two or more further binaural signals is associated with an associated relative rotational offset of the two or more relative rotational offsets, wherein the apparatus is configured to generate said binaural signal using the first binaural signal and using the rotational-offset-specific signal prediction information for said relative rotational offset.

71. An apparatus according to claim 66,
wherein the apparatus is configured to generate two or more further binaural signals as the one or more further binaural signals;
wherein two or more absolute poses depend on the pose information and/or depend on the rotational offset information; and the signal prediction information depends on pose-specific signal prediction information for each of the two or more absolute poses, such that each binaural signal of the two or more further binaural signals is associated with an associated absolute pose of the two or more absolute poses, wherein the apparatus is configured to generate a binaural signal for another absolute pose by interpolating or extrapolating the pose-specific signal prediction information for at least two of the two or more absolute poses depending on said other absolute pose to obtain interpolated or extrapolated pose-specific signal prediction information, and by generating the binaural signal for said other absolute pose using the first binaural signal and using the interpolated or extrapolated pose-specific signal prediction information; and/or
wherein two or more relative rotational offsets depend on the pose information and/or depend on the rotational offset information; and the signal prediction information depends on rotational-offset-specific signal prediction information for each of the two or more relative rotational offsets, such that each binaural signal of the two or more further binaural signals is associated with an associated relative rotational offset of the two or more relative rotational offsets, wherein the apparatus is configured to generate a binaural signal for another relative rotational offset by interpolating or extrapolating the rotational-offset-specific signal prediction information for at least two of the two or more relative rotational offsets depending on said other relative rotational offset to obtain interpolated or extrapolated rotational-offset-specific signal prediction information, and by generating the binaural signal for said other relative rotational offset using the first binaural signal and using the interpolated or extrapolated rotational-offset-specific signal prediction information.

72. An apparatus according to claim 69,
wherein the pose-specific signal prediction information for each absolute pose of the one or more absolute poses is a pose-specific prediction matrix for said absolute pose, wherein the apparatus is configured to generate the binaural signal being associated with said absolute pose by applying the pose-specific prediction matrix on the first binaural signal; and/or
wherein the interpolated or extrapolated pose-specific signal prediction information for said other absolute pose is a pose-specific prediction matrix for said other absolute pose, wherein the apparatus is configured to generate the binaural signal being associated with said other absolute pose by applying the pose-specific prediction matrix on the first binaural signal; and/or
wherein the offset-specific signal prediction information for each relative rotational offset of the one or more relative rotational offsets is an offset-specific prediction matrix for said relative rotational offset, wherein the apparatus is configured to generate the binaural signal being associated with said relative rotational offset by applying the offset-specific prediction matrix on the first binaural signal, and/or
wherein the interpolated or extrapolated rotational-offset-specific signal prediction information for said other relative rotational offset is an offset-specific prediction matrix for said other relative rotational offset, wherein the apparatus is configured to generate the binaural signal being associated with said other relative rotational offset by applying the offset-specific prediction matrix on the first binaural signal.

73. An apparatus according to claim 72,
wherein the pose-specific prediction matrix for said absolute pose is a 2×2 matrix, wherein the apparatus is configured to apply the pose-specific prediction matrix on a first channel and on a second channel of the first binaural signal to generate a first channel and a second channel of the binaural signal being associated with said absolute pose; and/or
wherein the offset-specific prediction matrix for said relative rotational offset is a 2×2 matrix, wherein the apparatus is configured to apply the offset-specific prediction matrix on a first channel and on a second channel of the first binaural signal to generate a first channel and a second channel of the binaural signal being associated with said relative rotational offset.

74. An apparatus according to claim 66,
wherein the first rotation and the one or more further rotations indicate different head poses of a head within the audio scene, such that the first binaural signal and the one or more further binaural signals are associated with the different head poses of the head.

75. An apparatus according to claim 74,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions.

76. An apparatus according to claim 66,
wherein one or more absolute poses depend on the pose information and/or depend on the rotational offset information; and the signal prediction information depends on pose-specific signal prediction information for each of the one or more absolute poses, such that each binaural signal of the one or more further binaural signals is associated with an associated absolute pose of the one or more absolute poses, wherein the apparatus is configured to generate said binaural signal using the first binaural signal and using the pose-specific signal prediction information for said absolute pose; and/or
wherein one or more relative rotational offsets depend on the pose information and/or depend on the rotational offset information; and the signal prediction information depends on rotational-offset-specific signal prediction information for each of the one or more relative rotational offsets, such that each binaural signal of the one or more further binaural signals is associated with an associated relative rotational offset of the one or more relative rotational offsets, wherein the apparatus is configured to generate said binaural signal using the first binaural signal and using the rotational-offset-specific signal prediction information for said relative rotational offset,
wherein the apparatus is configured to receive information on the absolute pose of the one or more further binaural signals and/or information on the associated relative rotational offset of the one or more binaural signals, e.g., from another apparatus.

77. An apparatus according to claim 69,
wherein the different head poses of the head are defined with respect to one or more Euler angles, and/or
wherein the different head poses of the head are defined with respect to at least one of a yaw angle and a pitch angle and a roll angle, and/or
wherein the different head poses of the head are defined with respect to a rotation matrix, and/or
wherein the different head poses of the head are defined with respect to one or more quaternions,
wherein the associated absolute pose, being associated with each of the two or more binaural signals and/or being associated with the prediction information, indicates the head pose of the head, being defined depending on the one or more Euler angles and/or the yaw angle and/or the pitch angle and/or the roll angle and/or the rotation matrix and/or the one or more quaternions; and/or
wherein the associated relative rotational offset, being associated with each of the two or more binaural signals and/or being associated with the prediction information, indicates a difference of a second head pose of the head with respect to a first head pose of the head, being defined depending on the one or more Euler angles and/or the yaw angle and/or the pitch angle and/or the roll angle and/or the rotation matrix and/or the one or more quaternions.

78. An apparatus according to claim 66,
wherein the apparatus is configured to receive the first binaural signal or an encoding thereof and the signal prediction information or an encoding thereof from another apparatus,
wherein the apparatus is configured to receive one or more transmissions from the other apparatus,
wherein the transmission comprises the first binaural signal being represented in a time domain, or
wherein the transmission comprises the first binaural signal being represented in a frequency domain, or
wherein the transmission comprises an encoding of the first binaural signal being represented in the time domain or in the frequency domain.

79. An apparatus according to claim 66,
wherein the apparatus is configured to receive the first binaural signal or an encoding thereof and the signal prediction information or an encoding thereof from another apparatus,
wherein the apparatus and the further apparatus are connected via a link with a delay.

80. An apparatus according to claim 66,
wherein the apparatus is configured to receive the first binaural signal or an encoding thereof and the signal prediction information or an encoding thereof from another apparatus,
wherein the apparatus is configured to transmit a rotational offset parameter as the rotational offset information to the other apparatus.

81. An apparatus according to claim 80,
wherein the rotational offset parameter depends on a current rotational offset and/or depends on a link latency.

82. An apparatus according to claim 66,
wherein the apparatus is configured to receive the first binaural signal or an encoding thereof and the signal prediction information or an encoding thereof from another apparatus,
wherein the apparatus is configured to transmit or to determine information on a link latency of the transmission.

83. An apparatus according to claim 66,
wherein the apparatus is configured to receive the first binaural signal or an encoding thereof and the signal prediction information or an encoding thereof from another apparatus,
wherein the apparatus is configured to receive or to determine information on a link latency of the transmission,
wherein the apparatus is configured to perform pose prediction depending on the link latency.

84. An apparatus according to claim 66,
wherein the apparatus is configured to receive the first binaural signal or an encoding thereof and the signal prediction information or an encoding thereof from another apparatus,
wherein the apparatus is configured to transmit a current rotational offset and/or one or more poses and/or upstream metadata for determining the rotational offset parameter to the other apparatus.

85. An apparatus according to claim 66,
wherein the apparatus is configured to receive the first binaural signal or an encoding thereof and the signal prediction information or an encoding thereof from another apparatus,
wherein the apparatus is configured to receive a rotational offset parameter as the rotational offset information from the other apparatus.

86. A system comprising,
one or more the apparatuses according to claim 66, and
an apparatus for generating signal prediction information, wherein the apparatus is configured to receive pose information and/or rotational offset information, wherein the apparatus is configured to generate a first binaural signal for a first rotation of an audio scene, and wherein the apparatus is configured to generate the signal prediction information depending on the pose information and/or the rotational offset information, such that one or more further binaural signals for one or more further rotations, being different from the first rotation, can be generated using the first binaural signal and using the signal prediction information.

87. A method for generating signal prediction information, wherein the method comprises:
receiving pose information and/or rotational offset information, and
generating a first binaural signal for a first rotation of an audio scene,
wherein generating the signal prediction information is conducted depending on the pose information and/or the rotational offset information, such that one or more further binaural signals for one or more further rotations, being different from the first rotation, can be generated using the first binaural signal and using the signal prediction information.

88. A method for generating one or more further binaural signals from a first binaural signal using signal prediction information, wherein the method comprises:
receiving the first binaural signal for a first rotation of an audio scene,
receiving signal prediction information which depends on pose information and/or which depends on rotational offset information, and
generating the one or more further binaural signals for one or more further rotations, being different from the first rotation using the first binaural signal and using the signal prediction information.

89. A non-transitory computer-readable medium comprising a computer program for implementing the method of claim 87 when being executed on a computer or signal processor.
